(19) United States
(12) Patent Application Publication
(10) Pub. No.: US 2013/0339885 A1
(43) Pub. Date: Dec. 19, 2013

(54) METHOD OF ASSIGNING IMPORTANCE TO CONTENTS AND ELECTRONIC DEVICE THEREFOR

(71) Applicant: Samsung Electronics Co. Ltd., Suwon-si (KR)

(72) Inventor: Yu-Youl EOM, Yongin-si (KR)

(21) Appl. No.: 13/915,748

(22) Filed: Jun. 12, 2013

(30) Foreign Application Priority Data
Jun. 14, 2012 (KR) 10-2012-0063832

(51) Int. Cl. G06F 3/048

(52) U.S. Cl. CPC G06F 3/048
USPC 715/764

(57) ABSTRACT

An apparatus and method for assigning a degree of importance to content in an electronic device is provided. The method includes displaying the content on a display unit, determining a marking region on the content displayed on the display unit, marking the marking region, and assigning the degree of importance to the marking region in consideration of marking information of the marking region.

### PRIORITY

This application claims the benefit under 35 U.S.C. §119(a) of a Korean patent application filed on Jun. 14, 2012 in the Korean Intellectual Property Office and assigned Serial No. 10-2012-0063832, the entire disclosure of which is hereby incorporated by reference.

### BACKGROUND OF THE INVENTION

1. Field of the Invention

The present invention relates to an electronic device. More particularly, the present invention relates to an apparatus and method for displaying degree of importance on digital content in an electronic device.

2. Description of the Related Art

While the use of multimedia services using portable electronic devices is increased, an amount of information which must be processed and displayed at each of the portable electronic devices is increased. Accordingly, there is a growing interest in portable electronic devices having a touch screen capable of improving space utilization degree and in increasing a size of a display unit.

The touch screen is an input and output device for performing an information input function and an information display function on one screen. Accordingly, the portable electronic devices include touch screen, the portable electronic devices may be configured so as to exclude a separate input device such as a keypad and the like, and thereby increase a display size.

As a screen size of the portable electronic device is enlarged as a result of the use of the touch screen, the use of digital content such as electronic documents is being increased by a user of the portable electronic device. Therefore, the portable electronic device needs various user interfaces for the convenience of the user who uses the digital content such as the electronic documents.

Therefore, a need exists for an apparatus and method for displaying importance for digital content in an electronic device.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to solve at least the above-mentioned problems and/or disadvantages and to provide at least the advantages described below. Accordingly, an aspect of the present invention is to provide an apparatus and method for displaying importance for digital content in an electronic device.

Another aspect of the present invention is to provide an apparatus and method for displaying importance through a marking service for digital content in an electronic device.

Another aspect of the present invention is to provide an apparatus and method for displaying importance in consideration of the number of times digital content is marked in an electronic device.

Another aspect of the present invention is to provide an apparatus and method for adjusting importance for digital content in an electronic device.

Another aspect of the present invention is to provide an apparatus and method for displaying importance on digital content in consideration of touch information in an electronic device.

Another aspect of the present invention is to provide an apparatus and method for displaying importance on digital content in consideration of touch information by an electronic pen or a finger of a user in an electronic device.

In accordance with an aspect of the present invention, a method of assigning a degree of importance to digital content in an electronic device is provided. The method includes displaying the digital content on a display unit, determining a marking region on the digital content displayed on the display unit, marking the marking region, and assigning the degree of importance to the marking region in consideration of marking information of the marking region.

In accordance with another aspect of the present invention, an electronic device is provided. The electronic device includes a display unit for displaying digital content, at least one processors, a memory, and a program which is stored in the memory and is executed by the at least one processor, wherein the at least one processor determines a marking region on the digital content displayed on the display unit, marks the marking region, and assigns a degree of importance to the marking region in consideration of marking information of the marking region.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating configuration of an electronic device according to an exemplary embodiment of the present invention;

FIG. 2 is a block diagram illustrating detailed configuration of a processor according to an exemplary embodiment of the present invention;

FIG. 3 is a flowchart illustrating a process of assigning importance to digital content according to an exemplary embodiment of the present invention;

FIG. 4 is a flowchart illustrating a process of additionally assigning importance to digital content according to an exemplary embodiment of the present invention;

FIGS. 5A to 5E are social network screens illustrating a process of assigning importance according to an exemplary embodiment of the present invention;

FIGS. 6A to 6E are social network screens illustrating a process of additionally assigning importance according to an exemplary embodiment of the present invention;

FIGS. 7A to 7E are social network screens illustrating a process of additionally assigning importance according to an exemplary embodiment of the present invention;

FIGS. 8A to 8E are social network screens illustrating a process of additionally assigning importance according to an exemplary embodiment of the present invention;

FIGS. 9A to 9E are electronic document screens illustrating a process of assigning importance according to an exemplary embodiment of the present invention;

FIGS. 10A to 10E are electronic document screens illustrating a process of additionally assigning importance according to an exemplary embodiment of the present invention;

FIGS. 11A to 11E are electronic document screens illustrating a process of additionally assigning importance according to an exemplary embodiment of the present invention;

FIGS. 12A to 12E are electronic document screens illustrating a process of additionally assigning importance according to an exemplary embodiment of the present invention;

FIGS. 13A to 13E are webpage screens illustrating a process of assigning importance according to an exemplary embodiment of the present invention;

FIGS. 14A to 14E are webpage screens illustrating a process of additionally assigning importance according to an exemplary embodiment of the present invention;

FIGS. 15A to 15E are webpage screens illustrating a process of additionally assigning importance according to an exemplary embodiment of the present invention;

FIGS. 16A to 16E are webpage screens illustrating a process of additionally assigning importance according to an exemplary embodiment of the present invention;

FIG. 17 is a flowchart illustrating a process of removing importance from digital content according to an exemplary embodiment of the present invention;

FIG. 18 is a flowchart illustrating a process of removing importance from digital content according to another embodiment of the present invention;

FIGS. 19A and 19B are screens illustrating a process of removing importance from digital content according to an exemplary embodiment of the present invention;

FIG. 20 is a flowchart illustrating a process of displaying importance information of digital content according to an exemplary embodiment of the present invention;

FIG. 21 is a flowchart illustrating a process of displaying importance information of digital content according to an exemplary embodiment of the present invention; and

FIGS. 22A to 22C are screens illustrating a process of displaying importance information of digital content according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Hereinafter, a description will be given for an apparatus and method for assigning importance to digital content in an electronic device. Herein, the digital content include electronic documents, webpages, Social Network Service (SNS) screens, and the like.

Hereinafter, the electronic device may be any one of a portable electronic device, a portable terminal, a mobile terminal, a mobile pad, a media player, a Personal Digital Assistant (PDA), a desktop computer, a laptop computer, a smart phone, a netbook, a television, a Mobile Internet Device (MID), a Ultra Mobile Personal Computer (UMPC), a tablet PC, a navigation device, a smart TV, a wrist watch, a digital camera, a Moving Picture Experts Group (MPEG) layer 3 (MP3) player, and the like, which may display digital content.

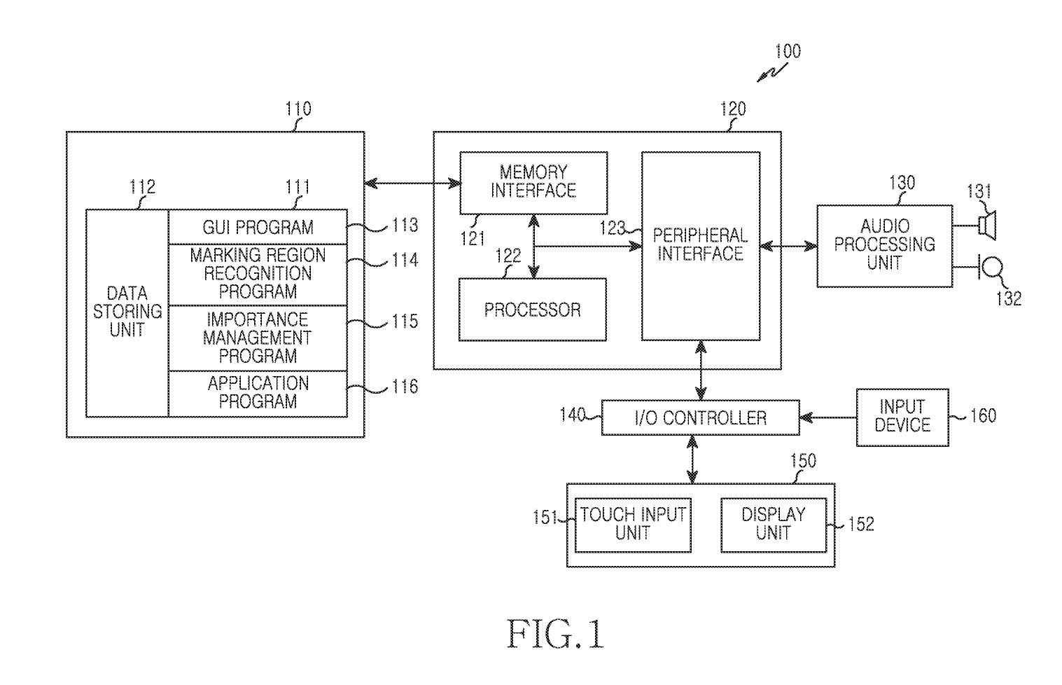

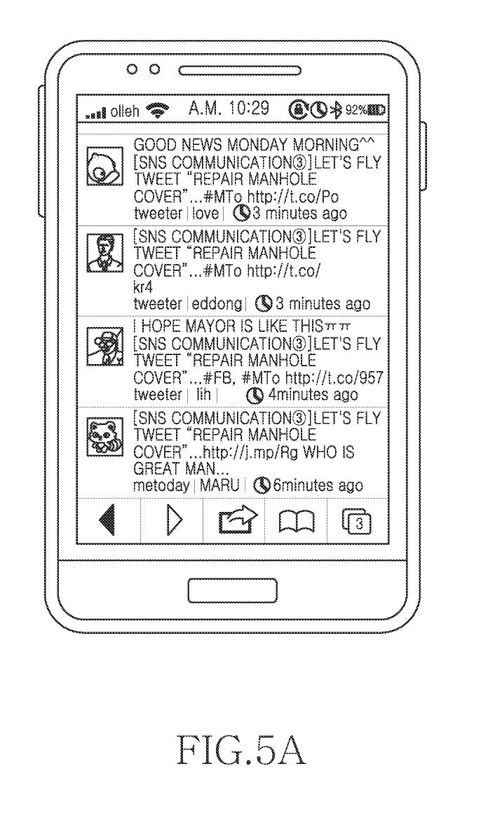

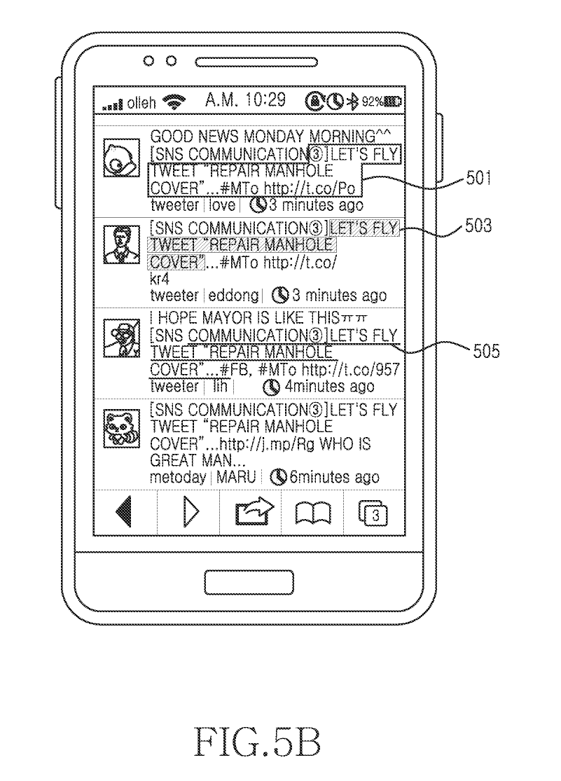

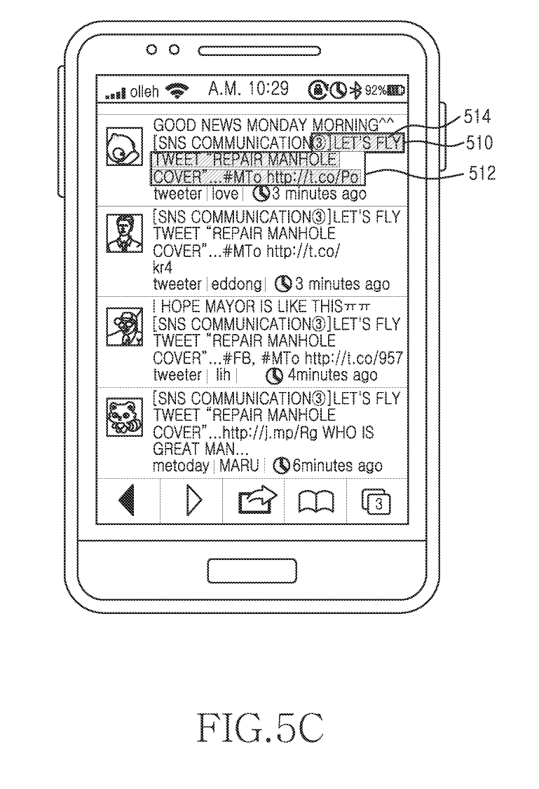

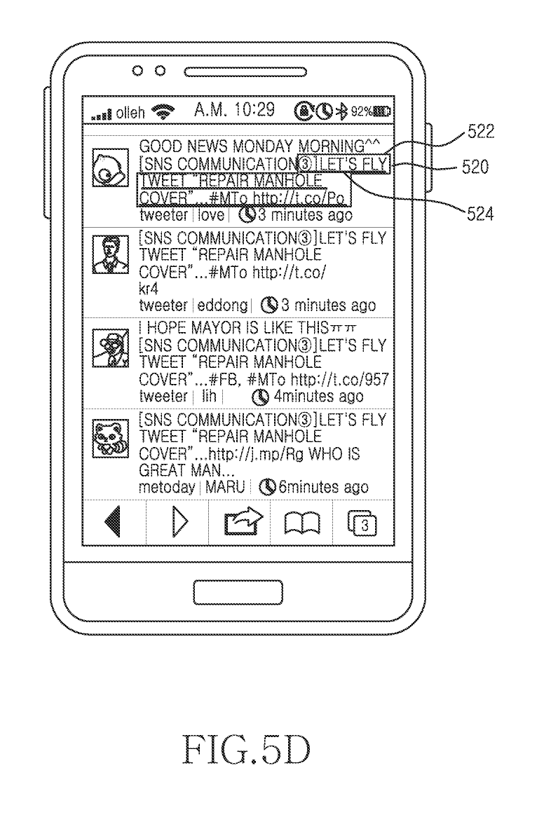

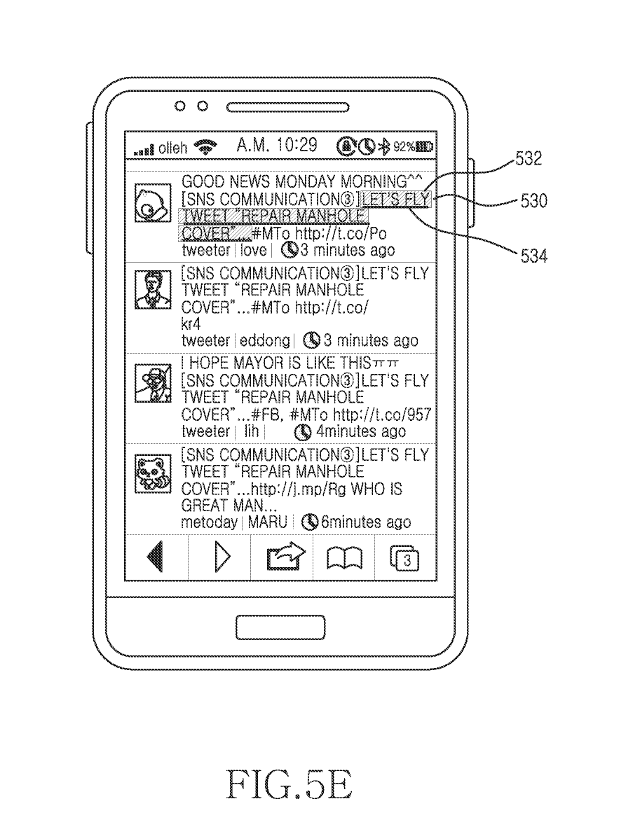

FIG. 1 is a block diagram illustrating configuration of an electronic device according to an exemplary embodiment of the present invention. FIGS. 5A to 5E are social network screens illustrating a process of assigning importance according to an exemplary embodiment of the present invention.

Referring to FIG. 1, the electronic device 100 is assumed to include a touch screen.

As illustrated in FIG. 1, the electronic device 100 includes a memory 110, a processor unit 120, an audio processing unit 130, an Input/Output (I/O) controller 140, a touch screen 150, and an input device 160.

A description will be given for each component is as follows.

According to exemplary embodiments of the present invention, the memory 110 may include a plurality of memories. The memory 110 includes a program storing unit 111 for storing a program for controlling an operation of the electronic device 100 and a data storing unit 112 for storing data items generated while the program is executed.

The data storing unit 112 may store content information of a marked marking region and importance information of the marking region.

The program storing unit 111 may include a Graphic User Interface (GUI) program 113, a marking region recognition program 114, an importance management program 115, and at least one application program 116. Herein, the programs included in the program storing unit 111 may be expressed in a set of instructions. Accordingly, the programs are expressed in an instruction set.

The marking region recognition program 114 includes at least one software component for determining a marking region in consideration of touch information sensed (e.g., detected) through a touch input unit 151 of the touch screen 150. For example, when the touch input unit 151 senses (e.g., detects) a touch of a user on a “LET'S FLY TWEET “REPAIR MANHOLE COVER” . . . #Mio http://t.co/Po” region on an SNS screen shown in FIG. 5A, the marking region recognition program 114 may recognize a “LET'S FLY TWEET “REPAIR MANHOLE COVER” . . . #Mio http://t.co/Po” region 501 shown in FIG. 5B as a marking region in consideration of touch information. If an additional touch of the user is sensed through the touch input unit 151, the marking region recognition program 114 may also recognize “LET'S FLY TWEET “REPAIR MANHOLE COVER”” region 503 and “COMMUNICATION\textcircled{3}] LET'S FLY TWEET “REPAIR MANHOLE COVER” . . . #” region 505 as marking regions in consideration of additional touch information.

The GUI program 113 includes at least one software component for providing a user interface as graphics on a display unit 152. In more detail, the GUI program 113 displays digital content on the display unit 152. When the digital content displayed on the display unit 152 include a marking region to which importance is assigned, the GUI program 113 may control the display unit 152 to mark the marking region according to the importance. The GUI program 113 may control the display unit 152 to mark the marking region recognized on the digital content displayed on the display unit 152 through the marking region recognition program 114 according to marking information. The GUI program 113 may also control the display unit 152 to mark the marking region according to predetermined marking information or a touch type sensed through the touch input unit 151. For one example, as shown in FIG. 5B, the GUI program 113 may control the display unit 152 to mark the “LET'S FLY TWEET “REPAIR MANHOLE COVER” . . . #Mio http://t.co/Po” region 501 recognized as the marking region through the marking region recognition program 114 with a box type according to predetermined marking information. As another example, as shown in FIG. 5B, the GUI program 113 may control the display unit 152 to mark the “LET'S FLY TWEET “REPAIR MANHOLE COVER”” region 503 recognized as the marking region through the marking region recognition program 114 with a highlighter type according to predetermined marking information. As another example, as shown in FIG. 5B, the GUI program 113 may control the display unit 152 to mark the “COMMUNICATION\textcircled{3}] LET'S FLY TWEET “REPAIR MANHOLE COVER” . . . #” region 505 recognized as the marking region through the marking region recognition program 114 with an underline type according to predetermined marking information. The predetermined marking information may be set to a basic value of the electronic device 100 or be set by the user. The marking information may include a marking type, a marking color, and the like, or a combination thereof.

If the marking region recognized through the marking region recognition program 114 is previously marked, the GUI program 113 may control the display unit 152 to mark the marking region additionally. For one example, as shown in FIGS. 5C to 5E, the GUI program 113 may control the display unit 152 to modify a marking type and mark a marking region additionally with the modified marking type.

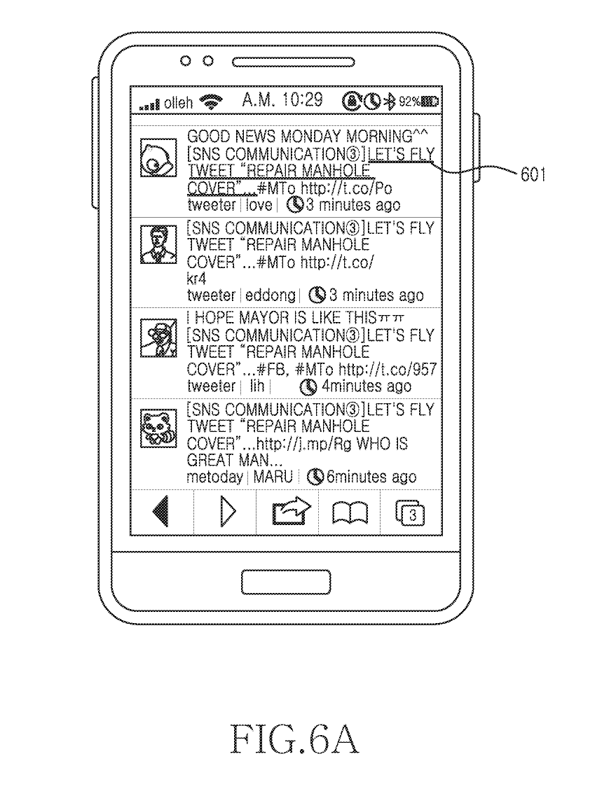

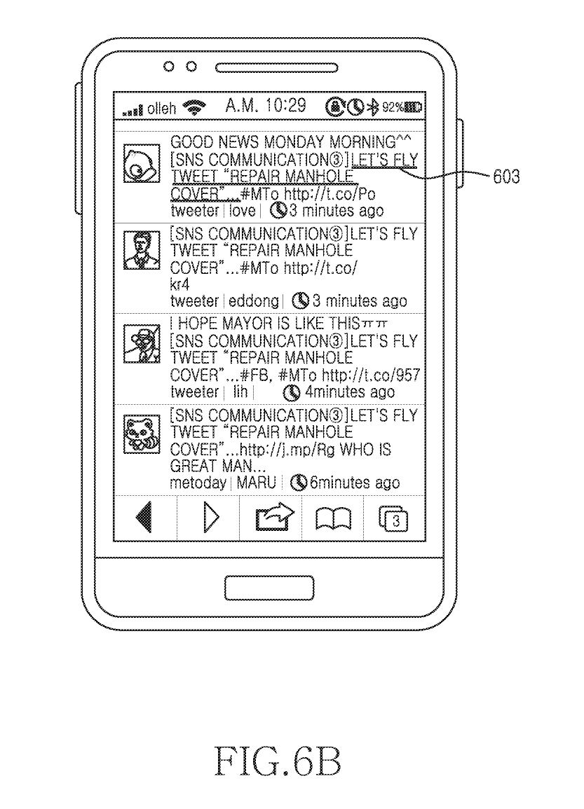

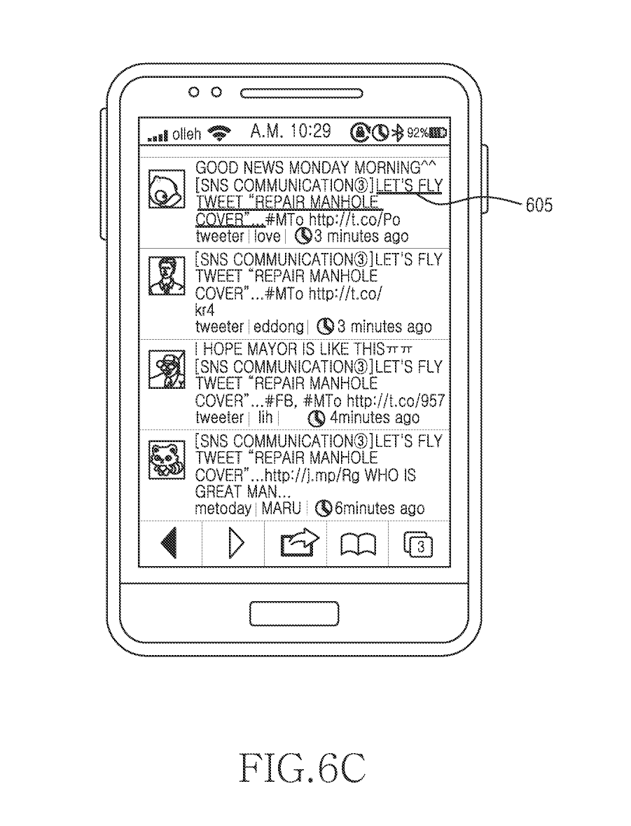

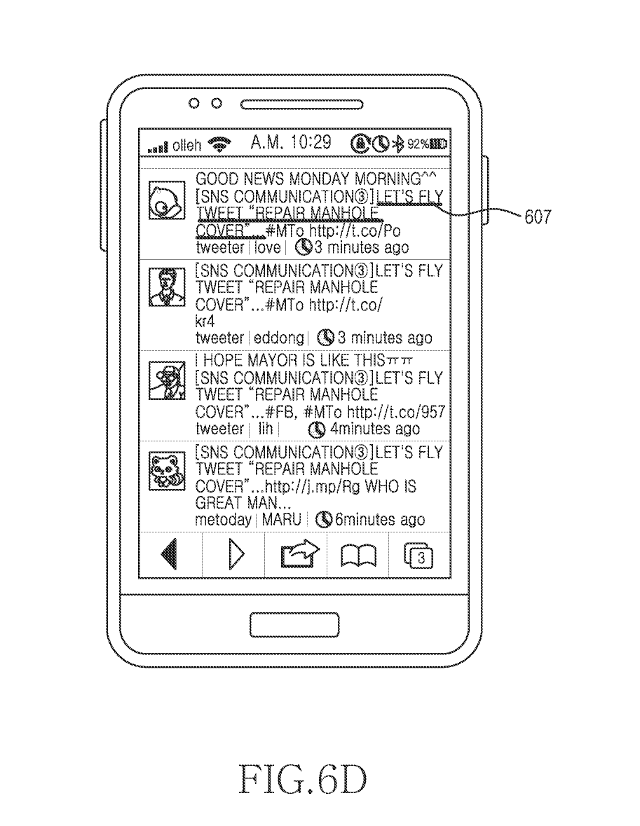

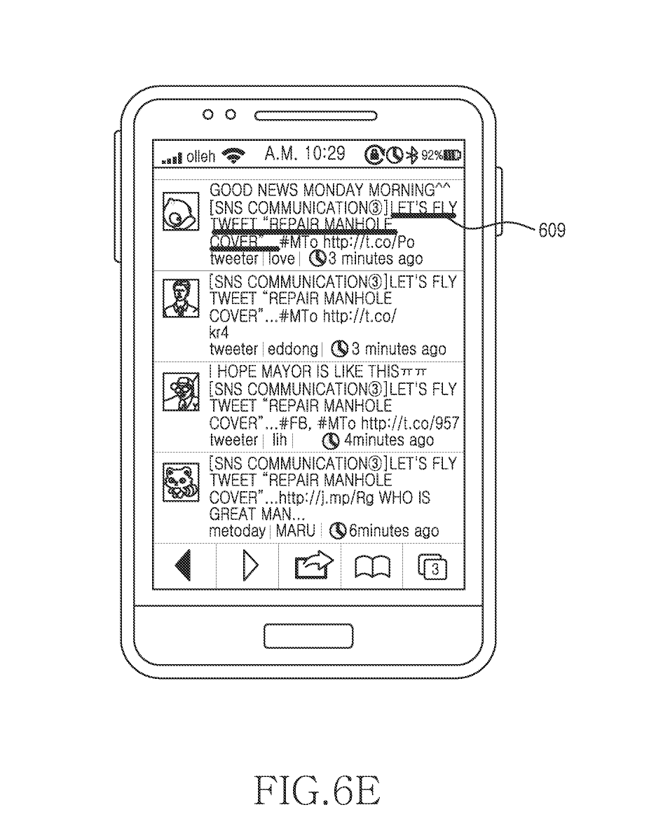

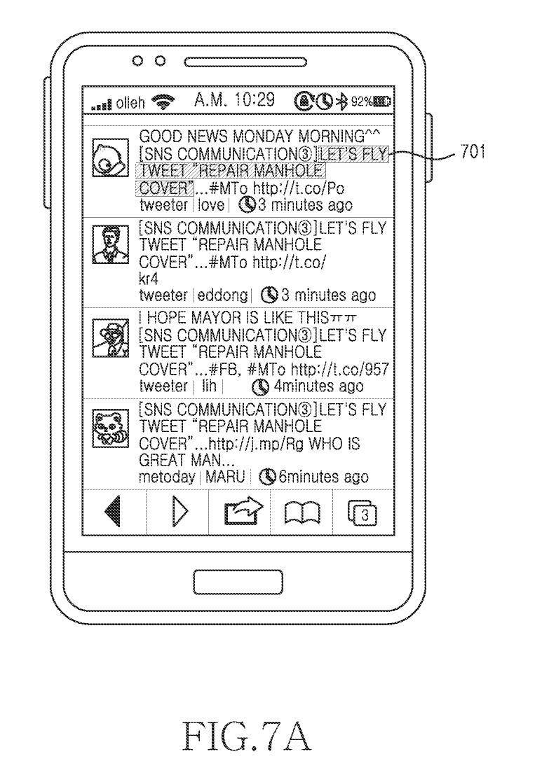

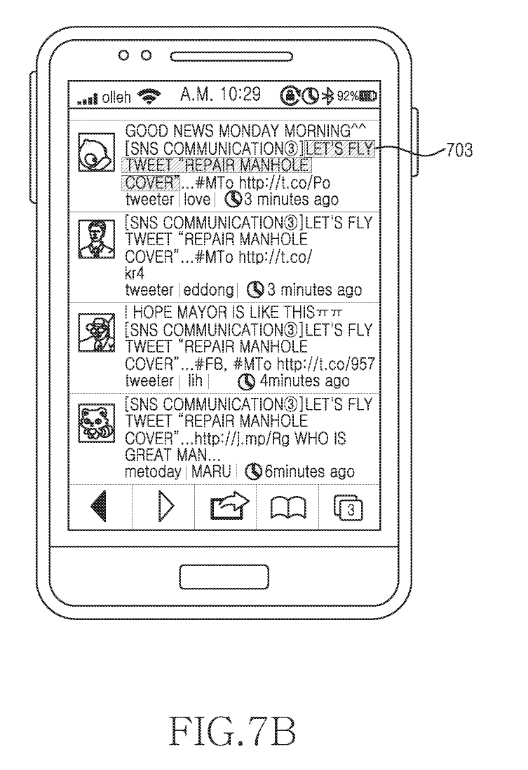

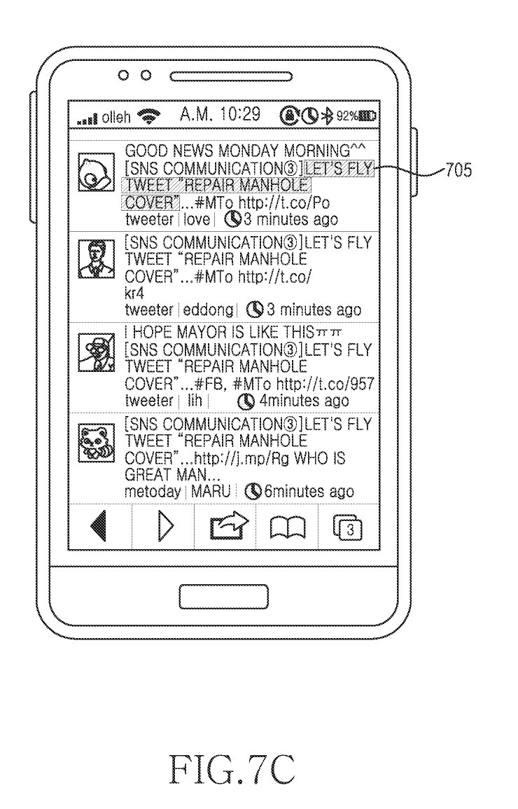

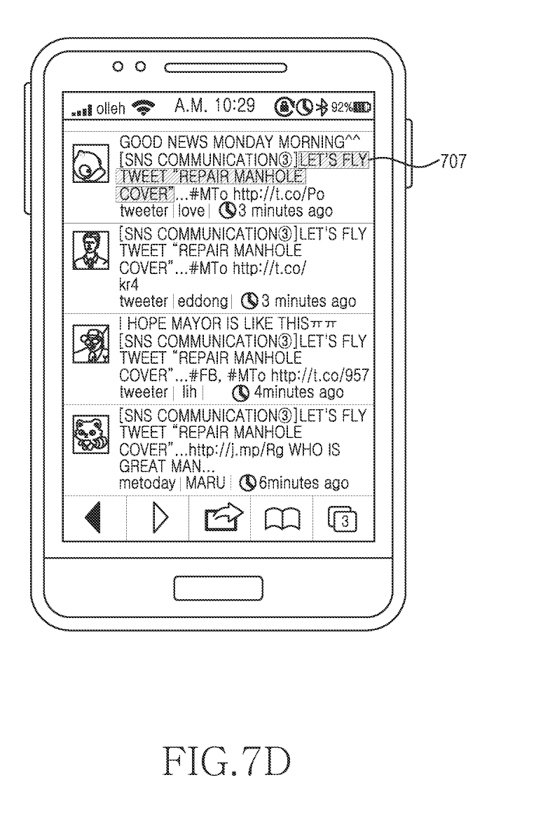

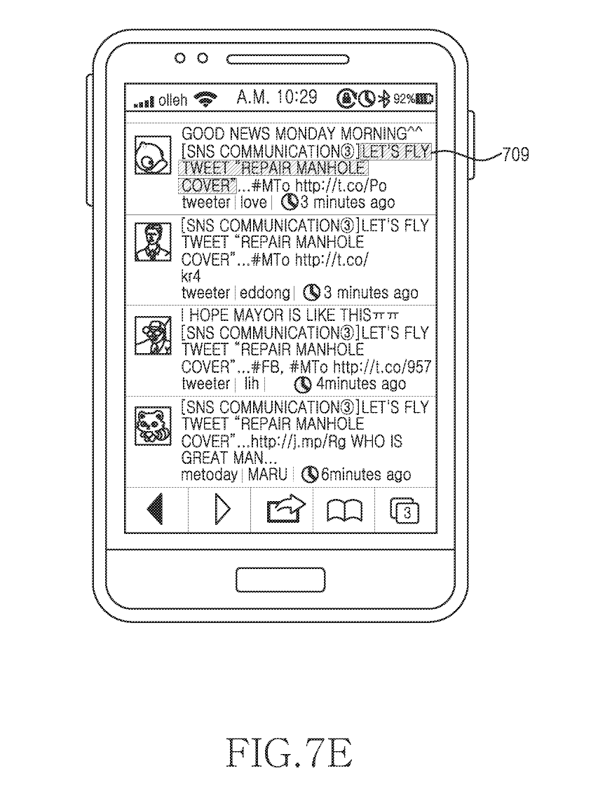

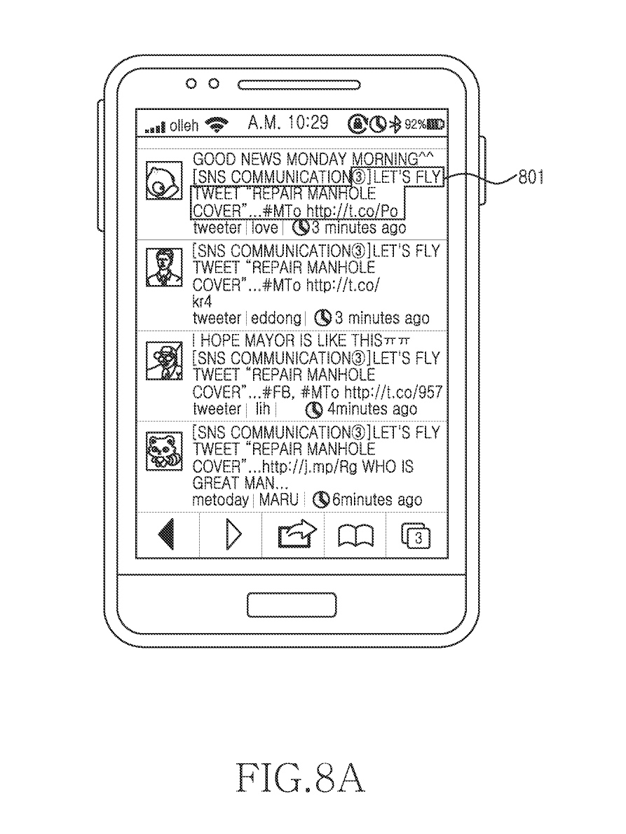

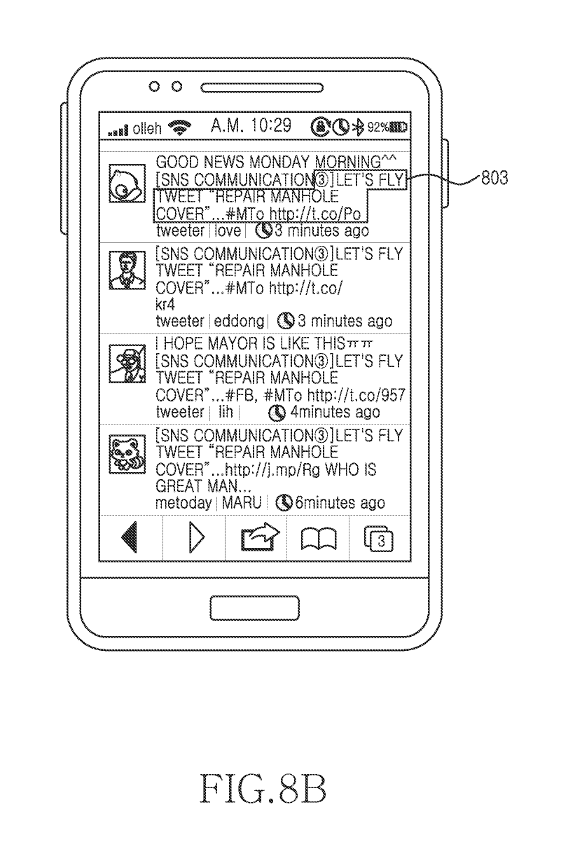

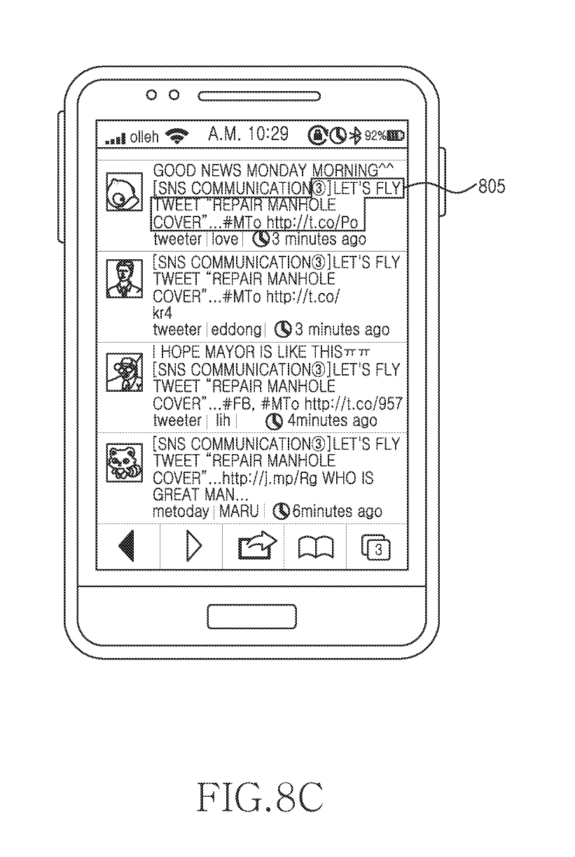

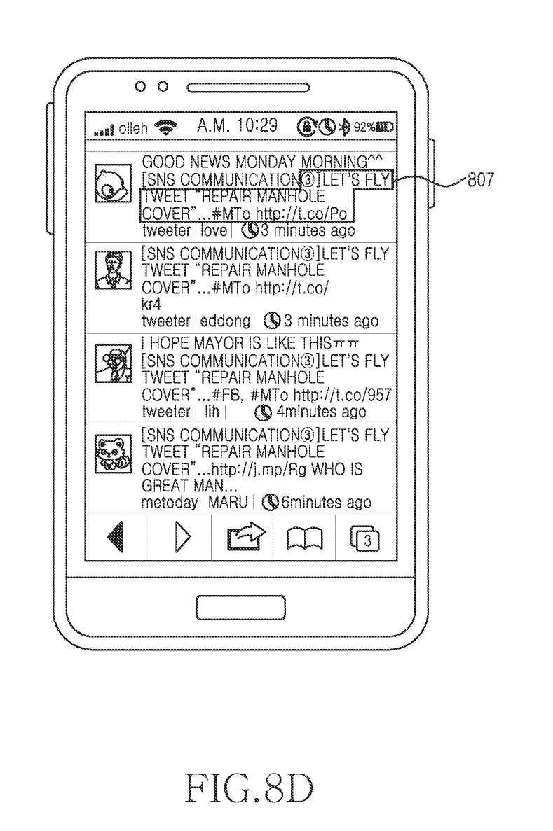

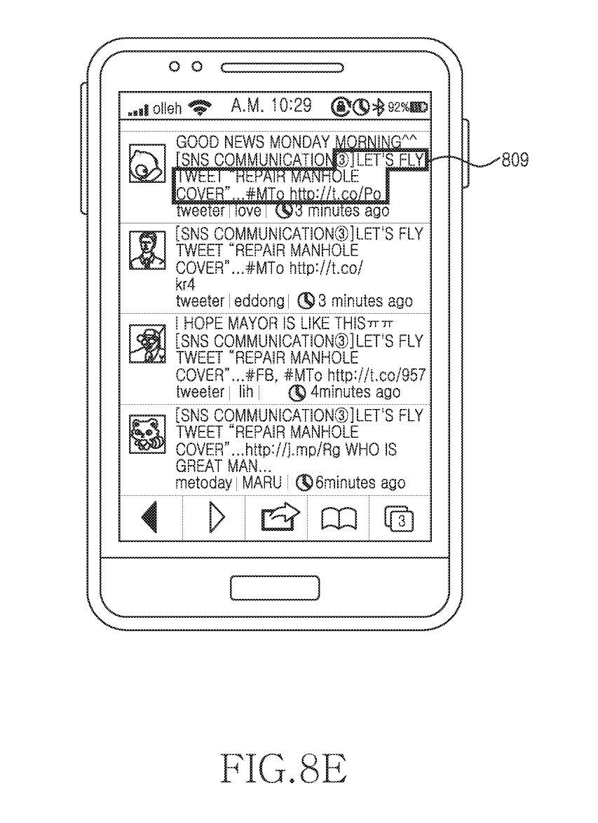

FIGS. 6A to 6E are social network screens illustrating a process of additionally assigning importance according to an exemplary embodiment of the present invention. FIGS. 7A to 7E are social network screens illustrating a process of additionally assigning importance according to an exemplary embodiment of the present invention. FIGS. 8A to 8E are social network screens illustrating a process of additionally assigning importance according to an exemplary embodiment of the present invention.

Referring to FIGS. 6A to 6C, 7A to 7C, and 8A to 8C, the GUI program 113 may also control the display unit 152 to modify a marking color and mark a marking region additionally with the modified marking color. Referring to FIGS. 6D and 6E, 7D and 7E, and 8D and 8E, the GUI program 113 may also control the display unit 152 to mark a marking region additionally with a shape in which the same marking types are overlapped.

When a marking removal event is generated, the GUI program 113 may control the display unit 152 to remove the marking of the marking region. For example, the GUI program 113 may control the display unit 152 to change the marking of the marking region in consideration of the number of times that the marking removal event is generated.

The importance management program 115 includes at least one software component for assigning importance to the marking region according to marking information of the marking region recognized through the marking region recognition program 114. For example, the importance management program 115 may assign an importance 3 to the first marking region 501 marked with the box type as shown in FIG. 5B. As another example, the importance management program 115 may assign an importance 2 to the second marking region 503 marked with the highlighter type as shown in FIG. 5B. As another example, the importance management program 115 may assign an importance 1 to the third marking region 505 marked with the underline type shown in FIG. 5B.

If the marking region is additionally marked by the GUI program 113, the importance management program 115 may update importance of the marking region according to additional marking information. For example, the importance management program 115 may update a first marking region 510 marked with a box type 512 and a highlighter type 514 as shown in FIG. 5C to an importance 5. As another example, the importance management program 115 may update a second marking region 520 marked with an underline type 524 and a box type 522 as shown in FIG. 5D to an importance 4. As another example, the importance management program 115 may update a third marking region 530 marked with an underline type 534 and a highlighter type 532 as shown in FIG. 5E to an importance 3.

When the marking of the marking region is removed by the GUI program 113, the importance management program 115 may lower importance of the marking region according to marking removal information.

As described above, when the importance management program 115 assigns importance to the marking region marked by the GUI program 113, the importance management program 115 extracts content information included in the marking region and stores the extracted content information in the data storing unit 112.

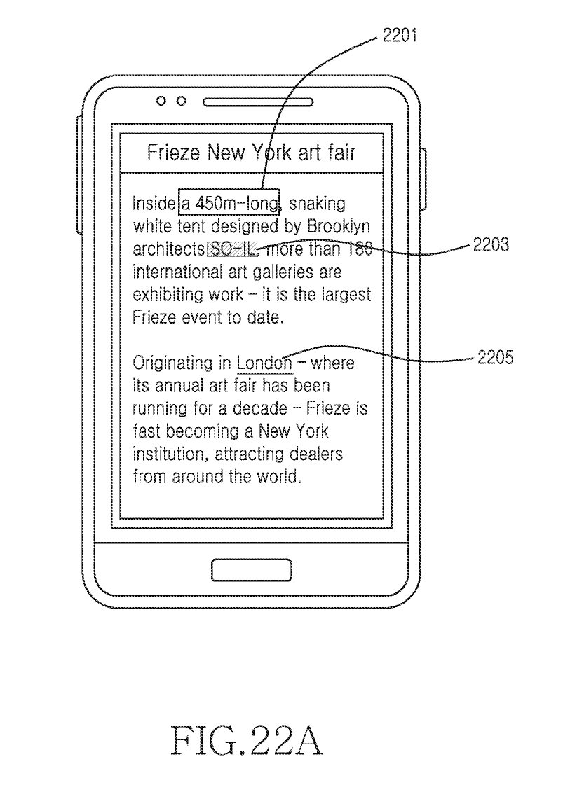

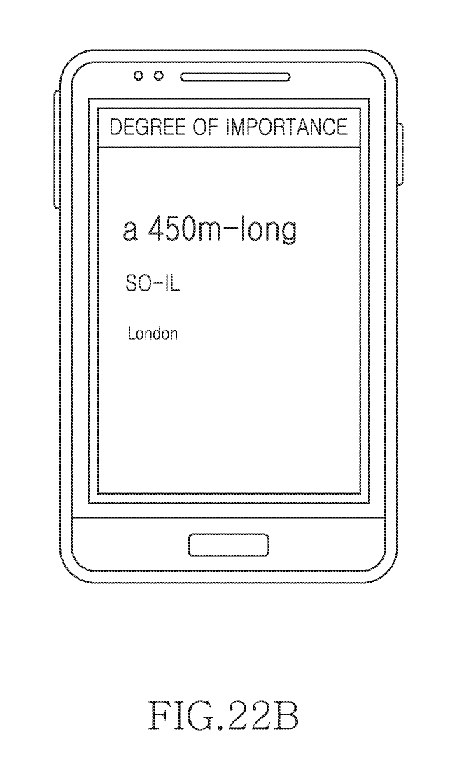

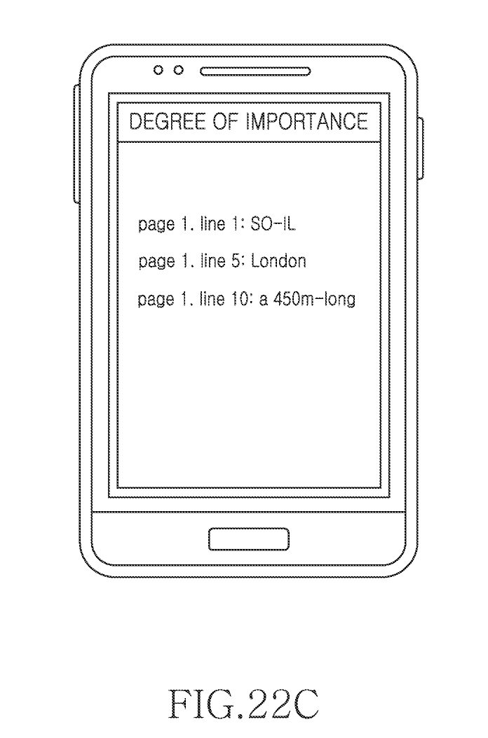

FIGS. 22A to 22C are screens illustrating a process of displaying importance information of digital content according to an exemplary embodiment of the present invention.

Referring to FIGS. 22A-22C, when an importance information search event is sensed, the importance management program 115 may include at least one software component for controlling the display unit 152 to display importance information stored in the data storing unit 112. As illustrated in FIG. 22A, various information may be marked as marked information. The marked information may be marked according to importance. For example, marked information 2201 may be associated with one level of importance; marked information 2203 may be associated with a second level of importance; and marked information 2205 may be associated with a third level of importance. For example, when an importance information search event is sensed, as shown in FIG. 22B, the importance management program 115 may control the display unit 152 to display a size of marked information differently according to importance. As another example, when an importance information search event is sensed, as shown in FIG. 22C, the importance management program 115 may control the display unit 152 to display position information of each marked information. The importance management program 115 may control the display unit 152 to display importance of each marked information together.

The importance management program 115 may include at least one software component for extracting personal characteristics of the user of the electronic device 100 using content information of a marking region to which importance is assigned, which is stored in the data storing unit 112. For example, when importance is assigned to “a 450 m-long” through an SNS and when importance is assigned to a “inside a 450 m-long” through a webpage, the importance management program 115 may recognize that the user has a lot of interest in the “a 450 m-long”. The importance management program 115 may extract personal characteristics of the user in consideration of only content information of a marking region having importance of a reference value or more. The reference value may include an importance average of marking regions to which importance is assigned, which is stored in the data storing unit 112.

The application program 116 includes a software component for at least one application program installed in the electronic device 100.

The processor unit 120 includes a memory interface 121, at least one processor 122, and a peripheral interface 123. The memory interface 121, at least the one processor 122, and the peripheral interface 123 which are included in the processor unit 120 may be integrated in at least one Integrated Circuit (IC) or be separately implemented.

The memory interface 121 controls to facilitate a component such as the processor 122 or the peripheral interface 123 access the memory 110.

The peripheral interface 123 controls connection among an I/O peripheral of the electronic device 100, the processor 122, and the memory interface 121.

The processor 122 provides a variety of multimedia services using at least one software program. The processor 122 executes at least one software program stored in the memory 110 and provides a service corresponding to the corresponding software program.

The audio processing unit 130 provides an audio interface between the user and the electronic device 100 through a speaker 131 and a microphone 132.

The I/O controller 140 provides an interface between I/O devices, such as the touch screen 150 and the input device 160, and the peripheral interface 123.

The touch screen 150 is an I/O device for inputting and outputting information. The touch screen 150 may include the touch input unit 151 and the display unit 152.

The touch input unit 151 provides touch information sensed through a touch panel to the processor unit 120 through the I/O controller 140. For example, the touch input unit 151 provides touch information by an electronic pen or a finger of the user to the processor unit 120 through the I/O controller 140.

The display unit 152 displays state information of the electronic device 100, characters input by the user, moving pictures, still pictures, and the like.

The input device 160 provides input data generated by selection of the user to the processor unit 120 through the I/O controller 140. For example, the input device 160 may include only a control button for controlling the electronic device 100. As another example, the input device 160 may include a keypad for receiving input data from the user.

Although it is not shown in FIG. 1, the electronic device 100 may further include a communication system for performing a communication function for voice communication and data communication. The communication system may be classified into a plurality of communication sub-modules which support different communication networks. For example, the communication network may be, but is not limited to, any one of a Global System for Mobile communication (GSM) network, an Enhanced Data GSM Environment (EDGE) network, a Code Division Multiple Access (CDMA) network, a Wideband-CDMA (W-CDMA) network, a Long Term Evolution (LTE) network, an Orthogonal Frequency Division Multiple Access (OFDMA) network, a wireless Local Area Network (LAN), a Bluetooth network, a Near Field Communication (NFC) network, and the like.

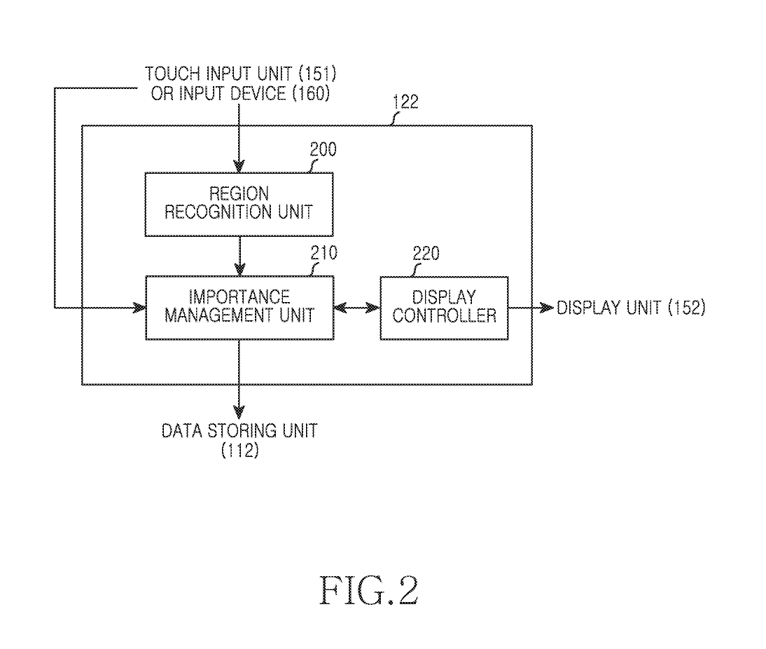

FIG. 2 is a block diagram illustrating detailed configuration of a processor according to an exemplary embodiment of the present invention.

Referring to FIGS. 1 and 2, the processor 122 may include a region recognition unit 200, an importance management unit 210, and a display controller 220.

The region recognition unit 200 executes the marking region recognition program 114 stored in the program storing unit 111 and determines a marking region in consideration of touch information sensed through the touch input unit 151. For example, when the touch input unit 151 senses a touch of the user on a “LET'S FLY TWEET “REPAIR MANHOLE COVER” . . . #Mio http://t.co/Po” region on an SNS screen, the region recognition unit 200 may recognize the “LET'S FLY TWEET “REPAIR MANHOLE COVER” . . . #Mio http://t.co/Po” region 501 shown in FIG. 5B as a marking region in consideration of touch information. If an additional touch of the user is sensed through the touch input unit 151, the region recognition unit 200 may also recognize “LET'S FLY TWEET “REPAIR MANHOLE COVER”” region 503 and “COMMUNICATION\textcircled{3}] LET'S FLY TWEET “REPAIR MANHOLE COVER” . . . #” region 505 as marking regions in consideration of additional touch information.

The display controller 220 executes the GUI program 113 stored in the program storing unit 111 and displays digital content on the display unit 152. When the digital content displayed on the display unit 152 include a marking region to which importance is assigned, the display controller 220 may control the display unit 152 to mark the marking region according to the importance.

The display controller 220 may control the display unit 152 to mark the marking region recognized at the region recognition unit 220 on digital content displayed on the display unit 152 according to marking information. For example, as shown in FIG. 5B, the display controller 220 may control the display unit 152 to mark the first marking region 501 with a box type. As another example, as shown in FIG. 5B, the display controller 220 may control the display unit 152 to mark the second marking region 503 with a highlighter type. As another example, as shown in FIG. 5B, the display controller 220 may control the display unit 152 to mark the third marking region 505 with an underline type. The marking information may be set as a basic value of the electronic device 100 or be set by the user. The marking information may include a marking type, a marking color, and the like, or a combination thereof.

If the marking region recognized at the region recognition unit 200 is previously marked, the display controller 220 may control the display unit 152 to mark the marking region additionally. For example, as shown in FIGS. 5C to 5E, the display controller 220 may control the display unit 152 to modify a marking type and mark a marking region additionally with the modified marking type. As another example, as shown in FIGS. 6A to 6C, 7A to 7C, and 8A to 8C, the display controller 220 may also control the display unit 152 to modify a marking color and mark a marking region additionally with the modified marking color. As another example, as shown in FIGS. 6D and 6E, 7D and 7E, and 8D and 8E, the display controller 220 may also control the display unit 152 to mark a marking region additionally with a shape in which the same marking types are overlapped.

When a marking removal event is generated, the display controller 220 may control the display unit 152 to remove the marking of the marking region. For example, the display controller 220 may control the display unit 152 to change the marking of the marking region in consideration of the number of times that the marking removal event is generated.

The importance management unit 210 executes the importance management program 115 stored in the program storing unit 111 and assigns importance to the marking region according to marking information of the marking region. For example, the importance management unit 210 may assign an importance 3 to the first marking region 501 marked with the box type shown in FIG. 5B. As another example, the importance management unit 210 may assign an importance 2 to the second marking region 503 marked with the highlighter type shown in FIG. 5B. As another example, the importance management unit 210 may assign an importance 1 to the third marking region 505 marked with the underline type as shown in FIG. 5B.

If additional marking information is displayed on the marking region by the display controller 220, the importance management unit 210 may update the importance of the marking region according to the additional marking information. For example, the importance management unit 210 may update a first marking region 510 marked with a box type 512 and a highlighter type 514 as shown in FIG. 5C to an importance 5. As another example, the importance management unit 210 may update a second marking region 520 marked with a box type 522 and an underline type 524 as shown in FIG. 5D to an importance 4. As another example, the importance management unit 210 may update a third marking region 530 marked with an underline type 534 and a highlighter type 532 as shown in FIG. 5E to an importance 3.

When the marking of the marking region is removed by the display controller 220, the importance management unit 210 may lower importance of the marking region according to marking removal information.

As described above, when importance is assigned to the marking region, the importance management unit 210 extracts content information included in the marking region and stores the extracted content information in the data storing unit 112. The importance management unit 210 stores importance information of the marking region together with content information included in the marking region.

In addition, when an importance information search event is sensed, the importance management unit 210 may control the display unit 152 to display importance information stored in the data storing unit 112. For example, when an importance information search event is sensed, as shown in FIG. 22B, the importance management unit 210 may control the display unit 152 to display a size of marked information differently according to importance. As another example, when an importance information search event is sensed, as shown in FIG. 22C, the importance management unit 210 may control the display unit 152 to display position information of each marked information. The importance management unit 210 may control the display unit 152 to display importance of each marked information together.

The importance management unit 210 may extract personal characteristics of the user of the electronic device 100 using content information of a marking region to which importance is assigned, which is stored in the data storing unit 112. For example, when importance is assigned to “a 450 m-long” through an SNS and when importance is assigned to “inside a 450 m-long” through a webpage, the importance management unit 210 may recognize that the user has a lot of interest in the “a 450 m-long”. The importance management unit 210 may extract personal characteristics of the user in consideration of only content information of a marking region having importance of a reference value or more. The reference value includes an importance average of marking regions to which importance is assigned, which is stored in the data storing unit 112.

As described above, when the importance management unit 210 extracts the personal characteristics of the user of the electronic device 100 using the content information of the marking region to which the importance is assigned, the electronic device 100 may control the provision of a service in consideration of the personal characteristics of the user. For example, when application programs to be downloaded are searched, the electronic device 100 may arrange and display an application program list in consideration of the personal characteristics of the user. As another example, the electronic device 100 may share the personal characteristics of the user through an SNS. In this case, the electronic device 100 may configure and manage a separate list of members who have similar characteristics to the personal characteristics of the user among SNS members.

According to exemplary embodiments of the present invention described above, the display controller 220 may execute the GUI program 113 and mark a marking region according to predetermined marking information. The display controller 220 may determine a marking type in consideration of touch information provided through the touch input unit 151. For example, when the user touches a marking region as a box type through the touch input unit 151, as shown in FIG. 5B, the display controller 220 may mark the first marking region 501 with the box type.

According to exemplary embodiments of the present invention described above, the processor 122 of the electronic device 100 may include the region recognition unit 200, the importance management unit 210, and the display controller 220, which execute the GUI program 113, the marking region recognition program 114, and the importance management program 115, mark a marking region, and assign importance to the marking region.

According to exemplary embodiments of the present invention, the electronic device 100 may be configured such that one processor 122 executes the GUI program 113, the marking region recognition program 114, and the importance management program 115.

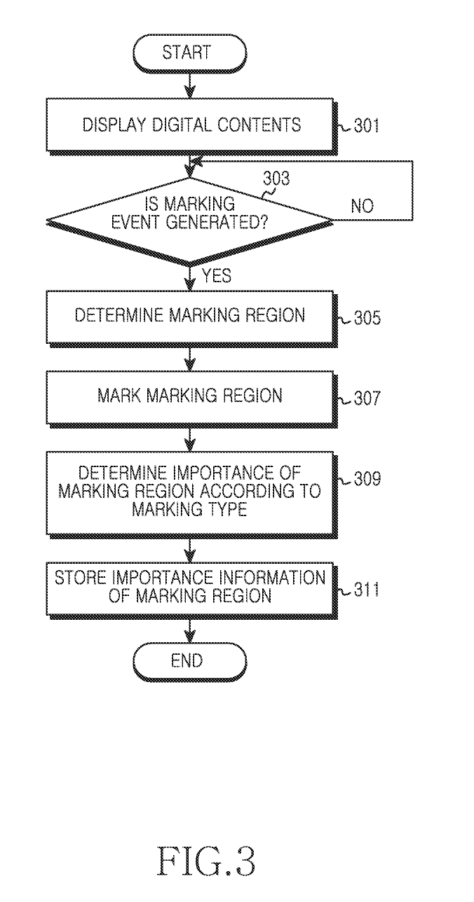

FIG. 3 is a flowchart illustrating a process of assigning importance to digital content according to an exemplary embodiment of the present invention.

Referring to FIGS. 1 and 3, the electronic device 100 displays digital content for providing a service in step 301. For example, the electronic device 100 displays any one of an SNS screen, an electronic document, and a webpage on the display unit 152 according to a kind of a service. If importance is set to the digital content, the electronic device 100 may mark a region to which the importance is assigned according to the importance.

The electronic device 100 proceeds to step 303 in which the electronic device 100 determines (e.g., determines) whether a marking event is generated. For one example, the electronic device 100 may determine whether a marking icon displayed on the display unit 152 is selected. As another example, the electronic device 100 may determine whether a marking setup menu is selected by an operation of the user. As another example, the electronic device 100 may determine whether a marking setup button is pushed. As another example, the electronic device 100 may determine whether marking setup information is received from a touch pen.

When the electronic device 100 determines that the marking event is generated in step 303, the electronic device 100 proceeds to step 305 in which the electronic device 100 determines a marking region in consideration of touch information sensed through the touch input unit 151. For example, the electronic device 100 may recognize a region touched on the digital content displayed on the display unit 151 by the user as a marking region.

After determining the marking region in step 305, the electronic device 100 proceeds to step 307 in which the electronic device 100 marks the marking region according to marking information determined in consideration of at least one of predetermined marking information and touch information. The electronic device 100 may use marking information which is set to a basic value or marking information used when providing a previous marking service. The marking information includes a marking type, a marking color, and the like, or a combination thereof. The marking type includes a box type, a highlighter type, and an underline type.

After marking the marking region in step 307, the electronic device 100 proceeds to step 309 in which the electronic device 100 determines importance of the marking region according to the marking information of the marking region. For example, the electronic device 100 may determine importance of the marking region in consideration of a marking type of the marking region. As another example, the electronic device 100 may determine importance of the marking region in consideration of a marking color of the marking region. As another example, the electronic device 100 may determine importance of the marking region in consideration of a marking type and a marking color of the marking region.

After determining importance of the marking region in step 309, the electronic device 100 proceeds to step 311 in which the electronic device 100 extracts content information included in the marking region, and stores the extracted content information together with importance information. For example, the electronic device 100 extracts text information included in the marking region and stores the extracted text information together with importance information. If the electronic device 100 stores a marking region included in a webpage, the electronic device 100 may store address information of the webpage additionally.

The electronic device 100 ends the algorithm of FIG. 3.

According to exemplary embodiments of the present invention described above, the electronic device 100 may mark a marking region in consideration of predetermined marking information.

According to exemplary embodiments of the present invention, the electronic device 100 may set marking information by an operation of the user before a marking event is generated. In this case, the electronic device 100 may set at least one of a marking type and a marking color to be used when marking a marking region by an operation of the user, an importance value according to the marking type, and an importance value according to the marking color.

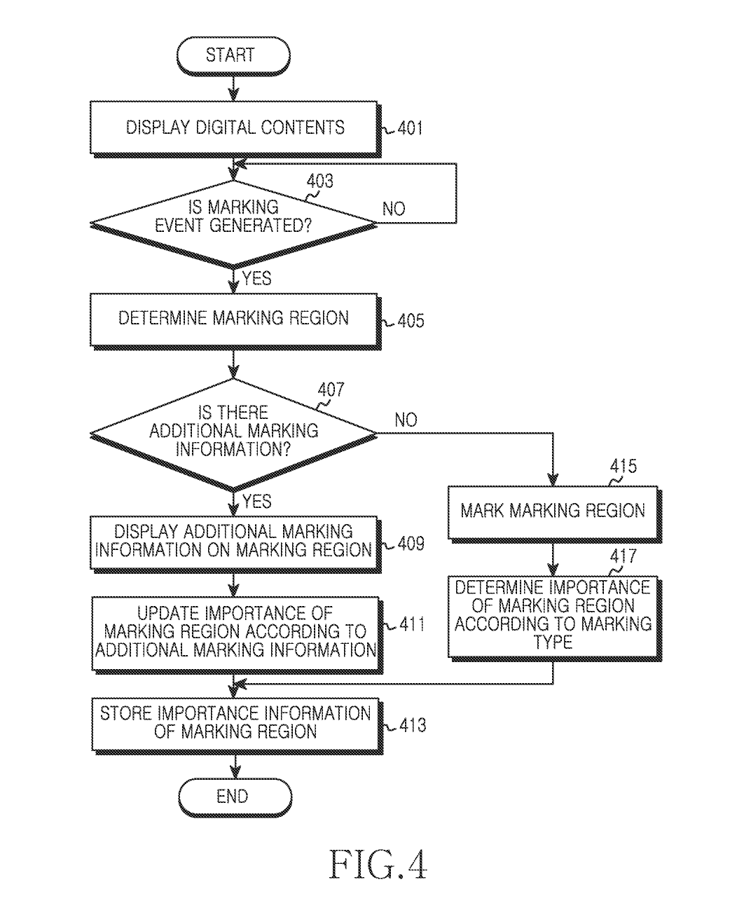

As described above, the electronic device 100 determines importance of a marking region according to marking information. In addition, as shown in FIG. 4, the electronic device 100 may mark a marking region many times.

FIG. 4 is a flowchart illustrating a process of additionally assigning importance to digital content according to an exemplary embodiment of the present invention.

Referring to FIGS. 1 and 4, the electronic device 100 displays digital content for providing a service in step 401. For example, the electronic device 100 displays any one of an SNS screen, an electronic document, and a webpage on the display unit 152 according to a kind of a service. If importance is set to the digital content, the electronic device 100 may mark a region to which the importance is assigned according to the importance.

The electronic device 100 proceeds to step 403 in which the electronic device 100 determines (e.g., determines) whether a marking event is generated. For example, the electronic device 100 may determine whether a marking icon displayed on the display unit 152 is selected. As another example, the electronic device 100 may determine whether a marking setup menu is selected by an operation of the user. As another example, the electronic device 100 may determine whether a marking setup button is pushed. As another example, the electronic device 100 may determine whether marking setup information is received from a touch pen.

When the electronic device 100 determines that the marking event is generated in step 403, the electronic device 100 proceeds to step 405 in which the electronic device 100 determines a marking region in consideration of touch information sensed through the touch input unit 151. For example, the electronic device 100 may recognize a region touched on the digital content displayed on the display unit 151 by the user as a marking region.

After determining the marking region in step 405, the electronic device 100 proceeds to step 407 in which the electronic device 100 determines (e.g., determines) whether the marking region determined in step 405 is previously marked.

If the electronic device 100 determines that the marking region determined in step 405 is not previously marked in step 407, then the electronic device 100 proceeds to step 415 in which the electronic device 100 marks the marking region according to marking information determined in consideration of at least one of predetermined marking information and touch information. The electronic device 100 may use marking information which is set to a basic value or marking information used when providing a previous marking service. Herein, the marking information includes a marking type and a marking color. The marking type includes a box type, a highlighter type, and an underline type.

After the electronic device 100 marks the marking region in step 415, the electronic device 100 proceeds to step 417 in which the electronic device 100 determines importance of the marking region according to the marking information of the marking region. For example, the electronic device 100 may determine importance of the marking region in consideration of a marking type of the marking region. As another example, the electronic device 100 may determine importance of the marking region in consideration of a marking color of the marking region. As another example, the electronic device 100 may determine importance of the marking region in consideration of a marking type and a marking color of the marking region.

Thereafter, the electronic device 100 proceeds to step 413 in which the electronic device 100 extracts content information included in the marking region, and stores the extracted content information together with importance information. For example, the electronic device 100 extracts text information included in the marking region and stores the extracted text information together with importance information.

If the electronic device 100 determines that the marking region determined in step 405 is previously marked in step 407, then the electronic device 100 may proceed to step 409 in which the electronic device 100 marks the marking region additionally. For one example, the electronic device 100 may modify a marking type and mark a marking region additionally with the modified marking type. As another example, the electronic device 100 may modify a marking color and mark a marking region additionally with the modified marking color. As another example, the electronic device 100 may mark a marking region additionally with a shape in which the same marking types are overlapped.

After additionally marking the marking region in step 409, the electronic device 100 proceeds to step 411 in which the electronic device 100 updates importance of the marking region according to additional marking information. The electronic device 100 may apply a weight value for updating importance to at least one of an additional marking type, an additional marking color, and the number of times additionally marking the marking region and update importance of the marking region.

After updating the importance of the marking region in step 411, the electronic device 100 proceeds to step 413 in which the electronic device 100 stores importance information of content information included in the marking region.

The electronic device 100 ends the algorithm of FIG. 4.

According to exemplary embodiments of the present invention described above, the electronic device 100 may mark a marking region in consideration of predetermined marking information. The electronic device 100 uses marking information which is set to a basic value or marking information used when providing a previous marking service.

According to exemplary embodiments of the present invention, the electronic device 100 may also set marking information by an operation of the user before a marking event is generated. In this case, the electronic device 100 may set at least one of a marking type and a marking color to be used when marking a marking region by an operation of the user, an importance value according to the marking type, and an importance value according to the marking color. For example, as shown in FIGS. 5A to 5E, electronic device 100 may assign importance according to marking information of a marking region on an SNS screen.

FIGS. 5A to 5E are social network screens illustrating a process of assigning importance to digital content according to one exemplary embodiment of the present invention.

Referring to FIG. 5A, when the electronic device 100 provides an SNS, the electronic device 100 displays an SNS screen on the display unit 152. The electronic device 100 marks a marking region of the SNS screen displayed on the display unit 152 in consideration of at least one of touch information provided from the touch input unit 151 and predetermined marking information. Referring to FIG. 5B, for example, when marking information is set to a blue box type, the electronic device 100 may mark the first marking region 501 of “LET'S FLY TWEET “REPAIR MANHOLE COVER” . . . #Mio http://t.co/Po” with the blue box type. As another example, when marking information is set to a red highlighter type, as shown in FIG. 5B, the electronic device 100 may mark the second marking region 503 of “LET'S FLY TWEET “REPAIR MANHOLE COVER”” with the red highlighter type according to the marking information. As another example, when marking information is set to a purple underline type, as shown in FIG. 5B, the electronic device 100 may mark the third marking region 505 of a “COMMUNICATION\textcircled{3}] LET'S FLY TWEET “REPAIR MANHOLE COVER” . . . #” with the purple underline type according to the marking information. As another example, when the user touches a marking region as a box type through the touch input unit 151, as shown in FIG. 5B, the electronic device 100 may mark the first marking region 501 of a “LET'S FLY TWEET “REPAIR MANHOLE COVER” . . . #Mio http://t.co/Po” with the box type. The electronic device 100 marks the first marking region 501 with a blue box type according to predetermined touch information. In this case, the electronic device 100 assigns importance of each of the first to third marking regions 501 to 503 according to a marking type and a marking color of each of the first to third marking regions 501 to 503. The electronic device 100 extracts content information included in each of the first to third marking regions 501 to 503 and stores the extracted content information together with importance.

If the marking region is previously marked, the electronic device 100 modifies a marking type and marks the marking region additionally with the modified marking type. Referring to FIG. 5C, as an example, when the first marking region 510 marked with the blue box type 512 will be additionally marked, the electronic device 100 may mark the first marking region 510 additionally with a red highlighter type 514. Referring to FIG. 5D, as another example, when the first marking region 520 marked with the blue box type 522 will be additionally marked, the electronic device 100 may mark the first marking region 520 with a red underline type 524 additionally. Referring to FIG. 5E, as another example, when the first marking region 530 marked with the red highlighter type 532 will be additionally marked, the electronic device 100 may mark the first marking region 530 with a red underline type 534 additionally and display a third additional marking region 514. For example, when a first marking region 510 marked with a red highlighter type 514 will be additionally marked, as shown in FIG. 5C, the electronic device 100 may mark the first marking region 510 with a blue box type 512 additionally. As another example, when a first marking region 520 marked with a red underline type 524 will be additionally marked, as shown in FIG. 5D, the electronic device 100 may mark the first marking region 520 with a blue box type 522 additionally. Referring to FIG. 5E, as another example, when a first marking region 530 marked with a red underline type 534 will be additionally marked, as shown in FIG. 5E, the electronic device 100 may mark the first marking region 530 with a red highlighter type 532 additionally. The electronic device 100 updates importance of the marking region in consideration of at least one of the additionally marked types and colors.

According to exemplary embodiments of the present invention described above, the electronic device 100 may modify a marking type and mark a marking region additionally with the modified marking type.

According to exemplary embodiments of the present invention, as shown in FIGS. 6A to 8E, the electronic device 100 may modify a marking color and mark a marking region with the modified marking color or a shape in which marking types are overlapped.

FIGS. 6A to 6E are social network screens illustrating a process of additionally assigning importance according to an exemplary embodiment of the present invention.

Referring to FIGS. 1 and 6A, the electronic device 100 may mark a marking region 601 of a “LET'S FLY TWEET “REPAIR MANHOLE COVER” . . . ” with a red (or other color) underline type on an SNS screen displayed on the display unit 152 in consideration of at least one of touch information provided from the touch input unit 151 and marking information.

If the marking region 601 will be additionally marked, the electronic device 100 may modify a marking color and mark a marking region additionally with the modified marking color. Referring to FIG. 6B, the electronic device 100 may mark the marking region 603 of the “LET'S FLY TWEET “REPAIR MANHOLE COVER” . . . ” additionally with a green underline type. Referring to FIG. 6C, if the marking region 603 will be additionally marked again, then the electronic device 100 may mark the marking region 605 of the “LET'S FLY TWEET “REPAIR MANHOLE COVER” . . . ” with a blue underline type. In this case, the electronic device 100 may update importance of the marking region 601 according to additional marking information. The electronic device 100 may apply a weight value for updating importance differently according to the number of times additionally marking the marking region.

In contrast, when the marking region 601 will be additionally marked, the electronic device 100 may mark the marking region 601 with a shape in which marking types are overlapped. Referring to FIG. 6D, as an example, the electronic device 100 may mark the marking region 607 of the “LET'S FLY TWEET “REPAIR MANHOLE COVER” . . . ” additionally with a shape in which red underlines are overlapped. Accordingly, the electronic device 100 may display the marking region 607 such that a width of the red underline of FIG. 6D is broader than that of the red underline of FIG. 6A. Referring to FIG. 6E, if the marking region 607 will be marked again, the electronic device 100 may mark the marking region 609 of the “LET'S FLY TWEET “REPAIR MANHOLE COVER” . . . ” additionally with a type in which red underlines are overlapped three times. Accordingly, the electronic device 100 may display the marking region 609 such that a width of the red underline of FIG. 6E is broader than that of the red underline of FIG. 6D. In this case, the electronic device 100 may update importance of the marking region 601 according to additional marking information. The electronic device 100 may apply a weight value for updating importance differently according to the number of times additionally marking the marking region.

FIGS. 7A to 7E are social network screens illustrating a process of additionally assigning importance according to an exemplary embodiment of the present invention.

Referring to FIGS. 1 and 7A, the electronic device 100 may mark a marking region 701 of a “LET'S FLY TWEET “REPAIR MANHOLE COVER”” with a red (or other color) highlighter type on an SNS screen displayed on the display unit 152 in consideration of at least one of touch information provided from the touch input unit 151 and marking information.

If the marking region 701 will be additionally marked, the electronic device 100 may modify a marking color and mark the marking region additionally with the modified marking color. Referring to FIG. 7B, as an example, the electronic device 100 may mark the marking region 703 of the “LET'S FLY TWEET “REPAIR MANHOLE COVER”” additionally with a green highlighter type. Referring to FIG. 7C, if the marking region 703 will be marked again and additionally, the electronic device 100 may mark the marking region 705 of the “LET'S FLY TWEET “REPAIR MANHOLE COVER”” with a blue highlighter type. In this case, the electronic device 100 may update importance of the marking region 701 according to additional marking information. The electronic device 100 may apply a weight value for updating importance differently according to the number of times additionally marking the marking region.

In contrast, when the marking region 701 will be additionally marked, the electronic device 100 may mark the marking region 701 with a shape in which marking types are overlapped. Referring to FIG. 6D, as an example, the electronic device 100 may mark the marking region 707 of the “LET'S FLY TWEET “REPAIR MANHOLE COVER”” additionally with a shape in which red highlighters are overlapped. Accordingly, the electronic device 100 may display the marking region 707 such that transparency of the red highlighter of FIG. 7D is darker than that of the red highlighter of FIG. 7A. Referring to FIG. 7E, if the marking region 707 will be marked again and additionally, the electronic device 100 may mark the marking region 709 additionally with a type in which red highlighters are overlapped three times. Accordingly, the electronic device 100 may display the marking region 709 such that the transparency of the red highlighter of FIG. 7E is darker than that of the red highlighter of FIG. 7D. In this case, the electronic device 100 updates importance of the marking region 701 according to additional marking information. The electronic device 100 may apply a weight value for updating importance differently according to the number of times additionally marking the marking region.

FIGS. 8A to 8E are social network screens illustrating a process of additionally assigning importance according to an exemplary embodiment of the present invention.

Referring to FIGS. 1 and 8A, the electronic device 100 may mark a marking region 801 of a “LET'S FLY TWEET “REPAIR MANHOLE COVER” . . . #Mio http://t.co/Po” with a blue (or other color) box type on an SNS screen displayed on the display unit 152 in consideration of at least one of touch information provided from the touch input unit 151 and marking information.

If the marking region 801 will be additionally marked, the electronic device 100 may modify a marking color and mark the marking region additionally with the modified marking color. Referring to FIG. 8B, as an example, the electronic device 100 may mark the marking region 803 of the “LET'S FLY TWEET “REPAIR MANHOLE COVER” . . . #Mio http://t.co/Po” additionally with a green box type. Referring to FIG. 8C, if the marking region 803 will be marked again and additionally, the electronic device 100 may mark the marking region 805 of the “LET'S FLY TWEET “REPAIR MANHOLE COVER” . . . #Mio http://t.co/Po” with a red box type. In this case, the electronic device 100 updates importance of the marking region 801 according to additional marking information. The electronic device 100 may apply a weight value for updating importance differently according to the number of times additionally marking the marking region.

In contrast, when the marking region 801 will be additionally marked, the electronic device 100 may mark the marking region 801 with a shape in which marking types are overlapped. Referring to FIG. 8D, as an example, the electronic device 100 may mark the marking region 807 of the “LET'S FLY TWEET “REPAIR MANHOLE COVER” . . . #Mio http://t.co/Po” additionally with a shape in which blue boxes are overlapped. Accordingly, the electronic device 100 may display the marking region 807 such that thickness of the blue box of FIG. 8D is thicker than that of the blue box of FIG. 8A. Referring to FIG. 8E, if the marking region 807 will be marked again and additionally, the electronic device 100 may mark the marking region 809 additionally with a type in which blue boxes are overlapped three times. Accordingly, the electronic device 100 may display the marking region 809 such that the thickness of the blue box of FIG. 8E is thicker than that of the blue box of FIG. 8D. In this case, the electronic device 100 updates importance of the marking region 801 according to additional marking information. The electronic device 100 may apply a weight value for updating importance differently according to the number of times additionally marking the marking region.

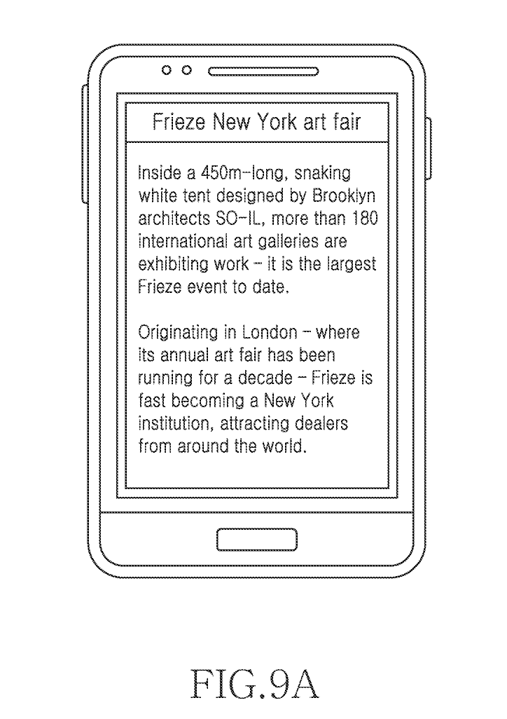

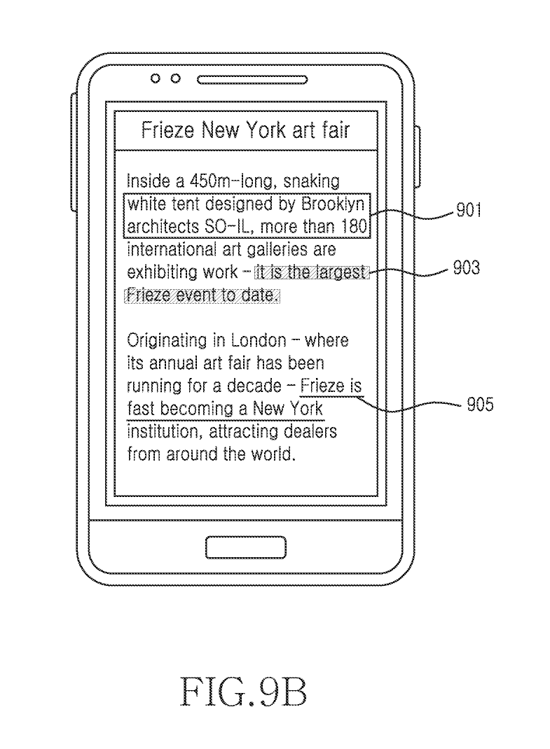

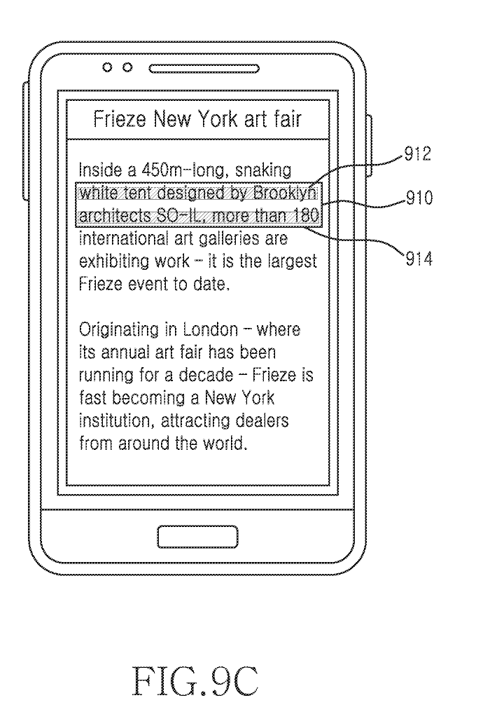

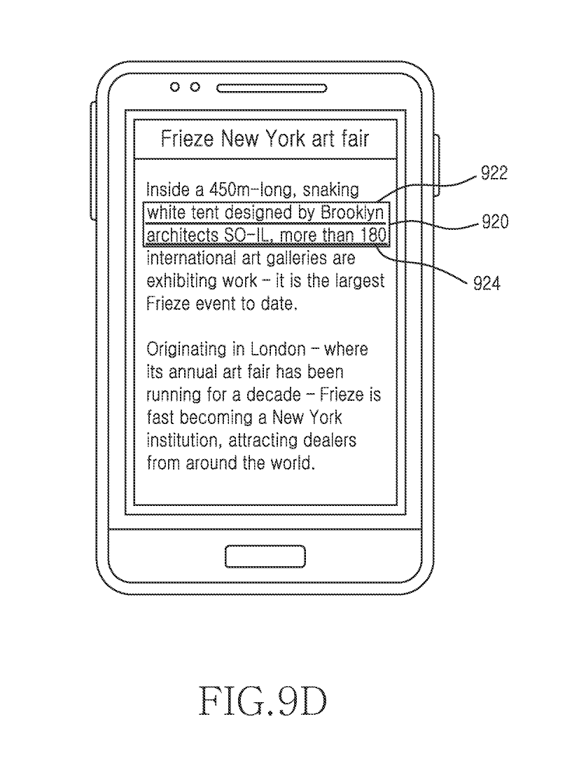

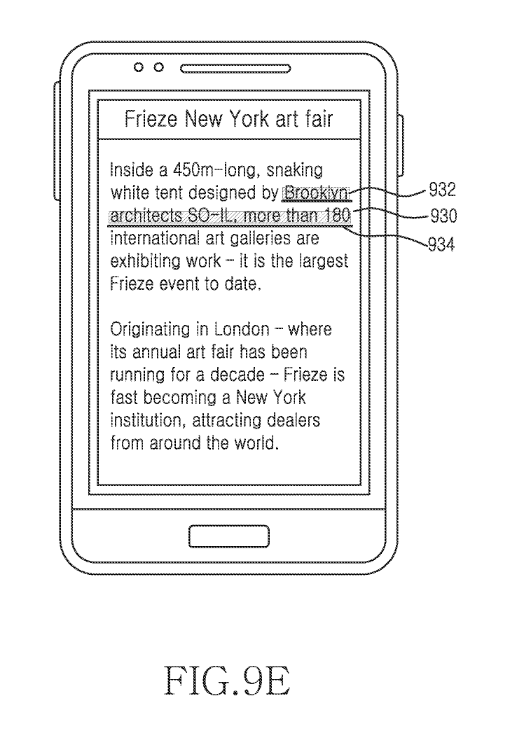

For another example, as shown in FIGS. 9A to 9E, the electronic device 100 may assign importance according to marking information of a marking region on an electronic document displayed on the display unit 152.

FIGS. 9A to 9E are electronic document screens illustrating a process of assigning importance according to an exemplary embodiment of the present invention.

Referring to FIG. 9A, when the electronic device 100 provides an electronic document service, the electronic device 100 displays an electronic document on the display unit 152. The electronic device 100 marks a marking region of the electronic document displayed on the display unit 152 in consideration of at least one of touch information provided from the touch input unit 151 and predetermined marking information. Referring to FIG. 9B, as an example, when marking information is set to a blue box type, the electronic device 100 may mark a first marking region 901 of “white tent designed by Brooklyn architects SO-IL, more than 180” with the blue box type. As another example, when marking information is set to a red highlighter type, as shown in FIG. 9B, the electronic device 100 may mark a second marking region 903 of “it is the largest Frieze event to date” with the red highlighter type according to the marking information. As another example, when marking information is set to a red underline type, as shown in FIG. 9B, the electronic device 100 may mark a third marking region 905 of a “Frieze is fast becoming a New York” with the red underline type according to the marking information. As another example, when the user touches a marking region as a box type through the touch input unit 151, as shown in FIG. 9B, the electronic device 100 may mark the first marking region 901 of the “white tent designed by Brooklyn architects SO-IL, more than 180” with the box type. The electronic device 100 marks the first marking region 901 with the blue box type according to predetermined touch information. The electronic device 100 assigns importance of each of the first to third marking regions 901 to 905 according to a marking type and a marking color of each of the first to third marking regions 901 to 903.

If the marking region is previously marked, the electronic device 100 modifies a marking type and marks the marking region additionally with the modified marking type. Referring to FIG. 9C, as an example, when the first marking region 910 marked with the blue box type 914 will be additionally marked, the electronic device 100 may mark the first marking region 910 with a red highlighter type 912 additionally. Referring to FIG. 9D, as another example, when the first marking region 920 marked with the blue box type 922 will be additionally marked, the electronic device 100 may mark the first marking region 920 with a red underline type 924 additionally. Referring to FIG. 9E, as another example, when the first marking region 930 marked with the red highlighter type 932 will be additionally marked, the electronic device 100 may mark the first marking region 930 with a red underline type 934 additionally. As another example, when a first marking region 910 marked with a red highlighter type 912 will be additionally marked, as shown in FIG. 9C, the electronic device 100 may mark the first marking region 910 with a blue box type 914 additionally. As another example, when a first marking region 920 marked with a red underline type 924 will be additionally marked, as shown in FIG. 9D, the electronic device 100 may mark the first marking region 920 with a blue box type 922 additionally. As another example, when a first marking region 930 marked with a red underline type 934 will be additionally marked, as shown in FIG. 9E, the electronic device 100 may mark the first marking region 930 with a red highlighter type 932 additionally. The electronic device 100 updates importance of the marking region in consideration of at least one of the additionally marked types and colors.

According to exemplary embodiments of the present invention, the electronic device 100 may modify a marking type and mark a marking region additionally with the modified marking type.

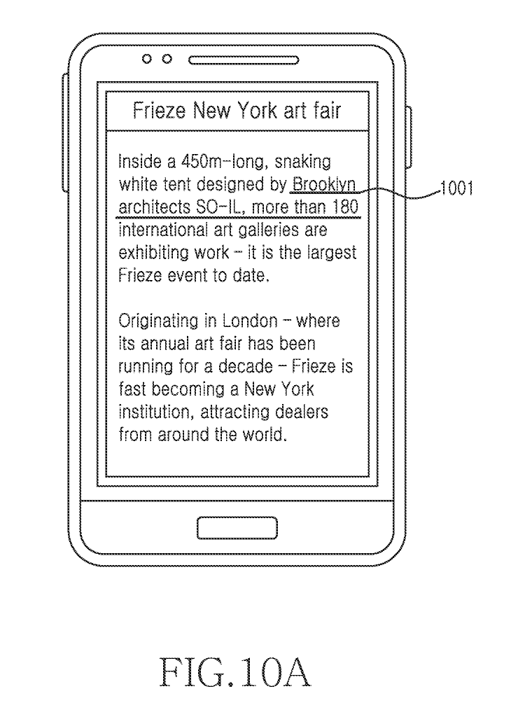

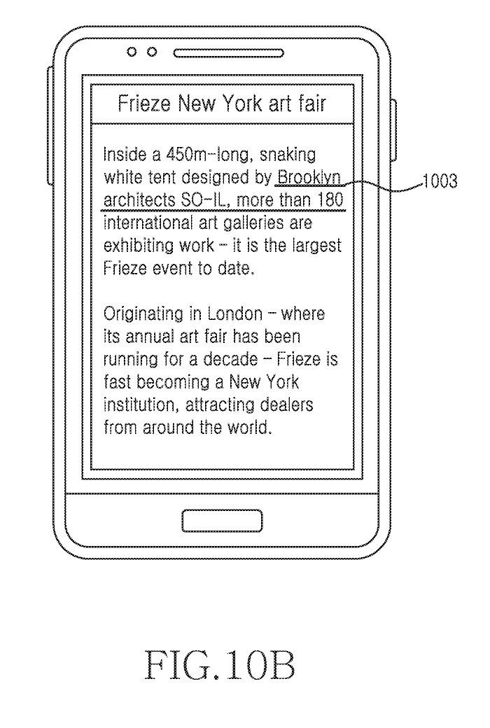

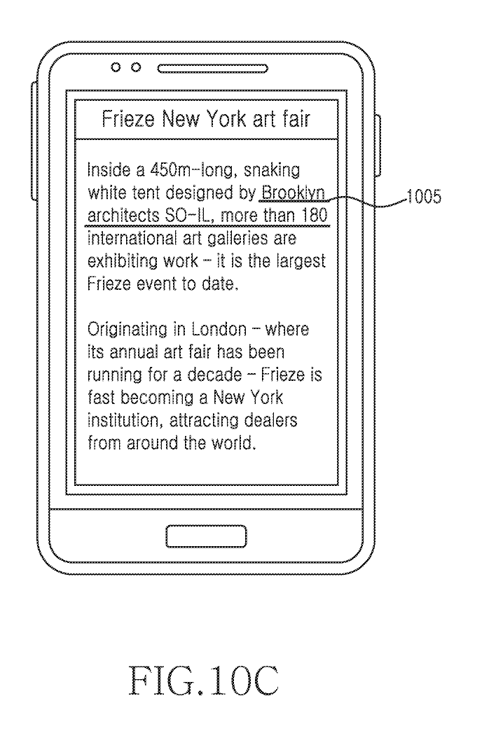

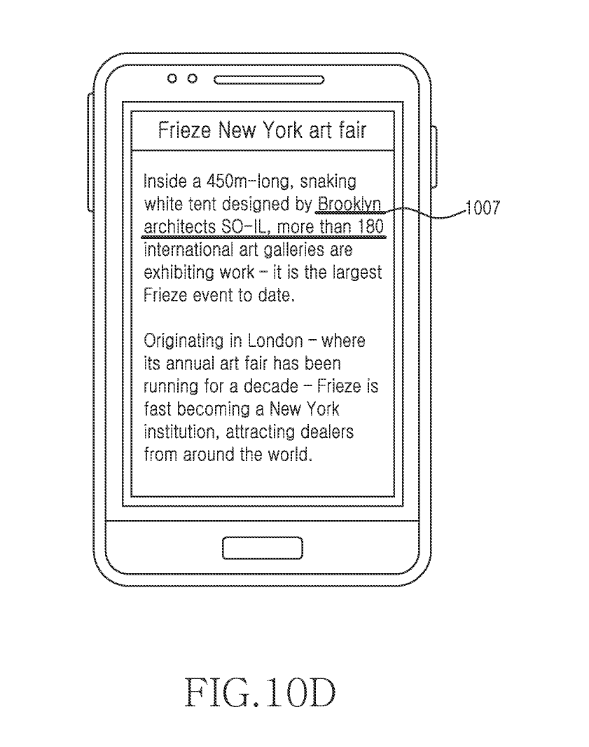

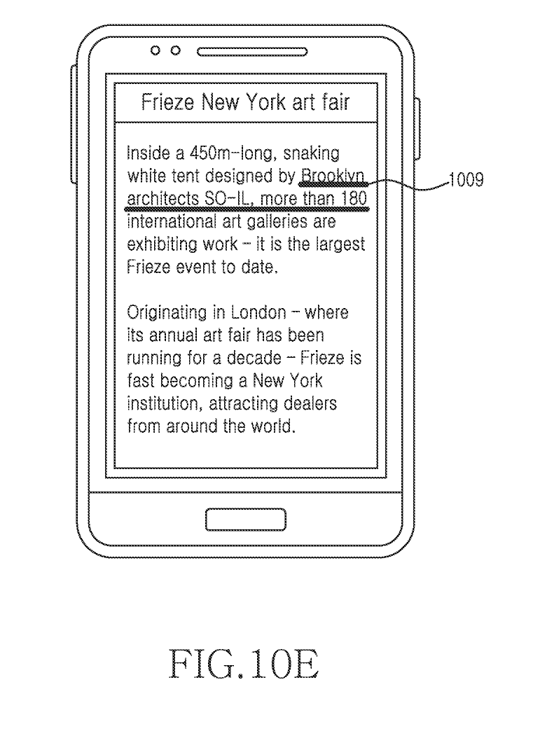

According to exemplary embodiment of the present invention, as shown in FIGS. 10A to 12E, the electronic device 100 may modify a marking color and mark a marking region with the modified marking color or a shape in which marking types are overlapped.

FIGS. 10A to 10E are electronic document screens illustrating a process of additionally assigning importance according to an exemplary embodiment of the present invention.

Referring to FIGS. 1 and 10A, the electronic device 100 may mark a marking region 1001 of a “Brooklyn architects SO-IL. More than 180” with a red underline type on an electronic document displayed on the display unit 152 in consideration of at least one of touch information provided from the touch input unit 151 and marking information.

If the marking region 1001 will be additionally marked, the electronic device 100 may modify a marking color and mark a marking region additionally with the modified marking color. Referring to FIG. 10B, as an example, the electronic device 100 may mark the marking region 1003 of the “Brooklyn architects SO-IL. More than 180” additionally with a green underline type. Referring to FIG. 10C, if the marking region 1003 will be marked again and additionally, the electronic device 100 may mark the marking region 1005 of the “Brooklyn architects SO-IL. More than 180” with a blue underline type. In this case, the electronic device 100 updates importance of the marking region 1001 according to additional marking information. Herein, the electronic device 100 may apply a weight value for updating importance differently according to the number of times additionally marking the marking region.

In contrast, when the marking region 1001 will be additionally marked, the electronic device 100 may mark the marking region 1001 with a shape in which marking types are overlapped. Referring to FIG. 10D, as an example, the electronic device 100 may mark the marking region 1007 of the “Brooklyn architects SO-IL. More than 180” additionally with a shape in which red underlines are overlapped. Accordingly, the electronic device 100 may display the marking region 1007 such that a width of the red underline of FIG. 10D is broader than that of the red underline of FIG. 10A. Referring to FIG. 10E, if the marking region 1007 will be marked again and additionally, the electronic device 100 may mark the marking region 1009 additionally with a type in which red underlines are overlapped three times. Accordingly, the electronic device 100 may display the marking region 1009 such that a width of the red underline of FIG. 10E is broader than that of the red underline of FIG. 10D. In this case, the electronic device 100 may update importance of the marking region 1001 according to additional marking information. The electronic device 100 may apply a weight value for updating importance differently according to the number of times additionally marking the marking region.

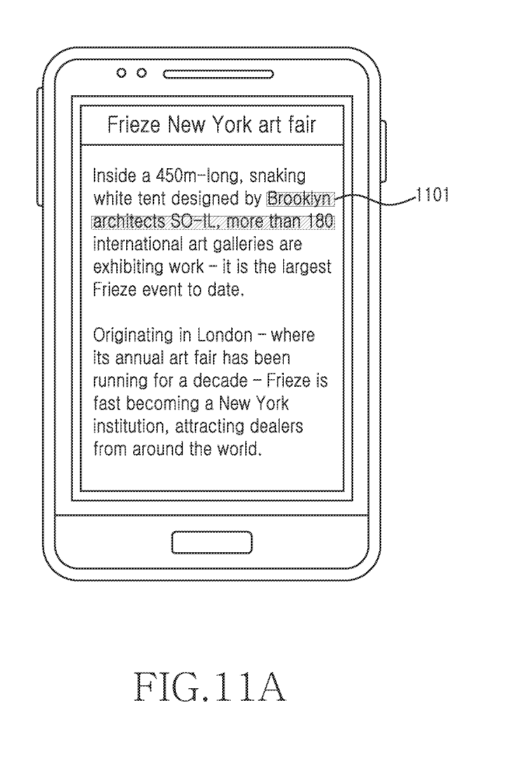

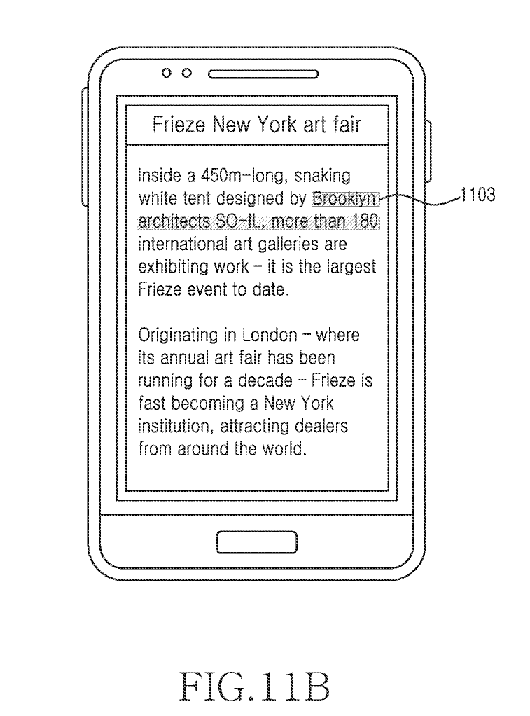

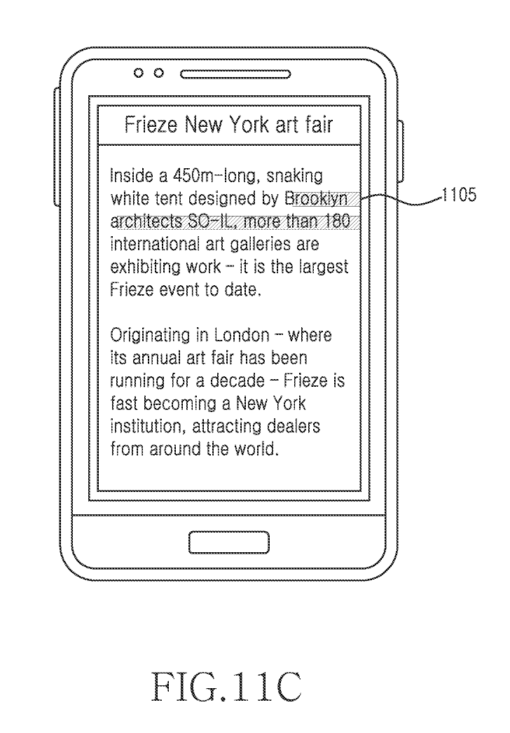

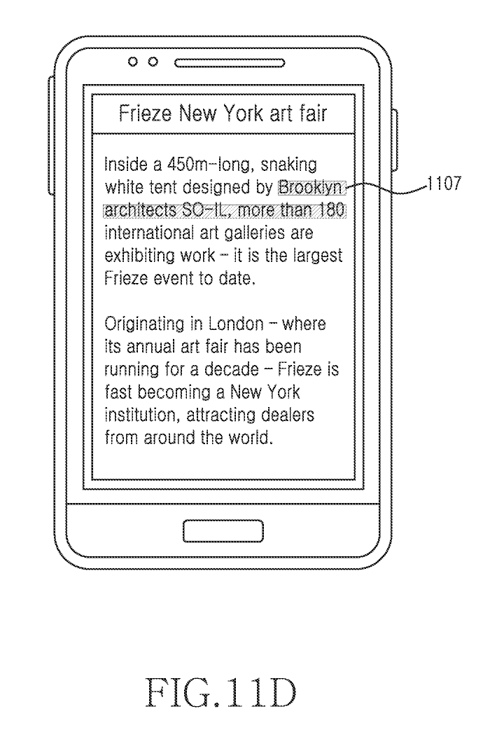

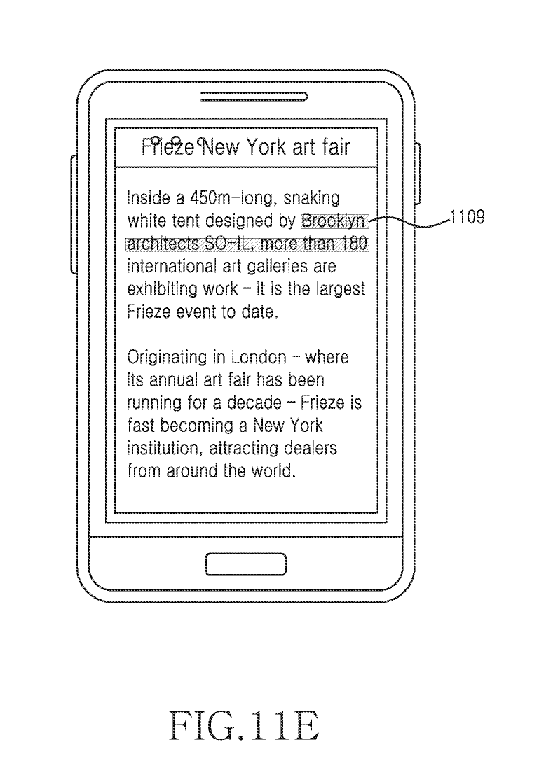

FIGS. 11A to 11E are electronic document screens illustrating a process of additionally assigning importance according to an exemplary embodiment of the present invention.

Referring to FIGS. 1 and 11A, the electronic device 100 may mark a marking region 1101 of a “Brooklyn architects SO-IL. More than 180” with a red highlighter type on an electronic document displayed on the display unit 152 in consideration of at least one of touch information provided from the touch input unit 151 and marking information.

If the marking region 1101 will be additionally marked, the electronic device 100 may modify a marking color and mark the marking region additionally with the modified marking color. Referring to FIG. 11B, as an example, the electronic device 100 may mark the marking region 1103 of the “Brooklyn architects SO-IL. More than 180” additionally with a green highlighter type. Referring to FIG. 11C, if the marking region 1103 will be marked again and additionally, the electronic device 100 may mark the marking region 1105 of the “Brooklyn architects SO-IL. More than 180” with a blue highlighter type. In this case, the electronic device 100 may update importance of the marking region 1101 according to additional marking information. The electronic device 100 may apply a weight value for updating importance differently according to the number of times additionally marking the marking region.

In contrast, when the marking region 1101 will be additionally marked, the electronic device 100 may mark the marking region 1101 with a shape in which marking types are overlapped. Referring to FIG. 11D, as an example, the electronic device 100 may mark the marking region 1107 of the “Brooklyn architects SO-IL. More than 180” additionally with a shape in which red highlighters are overlapped. Accordingly, the electronic device 100 may display the marking region 1107 such that transparency of the red highlighter of FIG. 11D is darker than that of the red highlighter of FIG. 11A. Referring to FIG. 11E, if the marking region 1107 will be marked again, the electronic device 100 may additionally mark the marking region 1109 of the “Brooklyn architects SO-IL. More than 180” additionally with a type in which red highlighters are overlapped three times. Accordingly, the electronic device 100 may display the marking region 1109 such that the transparency of the red highlighter of FIG. 11E is darker than that of the red highlighter of FIG. 11D. In this case, the electronic device 100 updates importance of the marking region 1101 according to additional marking information. The electronic device 100 may apply a weight value for updating importance differently according to the number of times additionally marking the marking region.

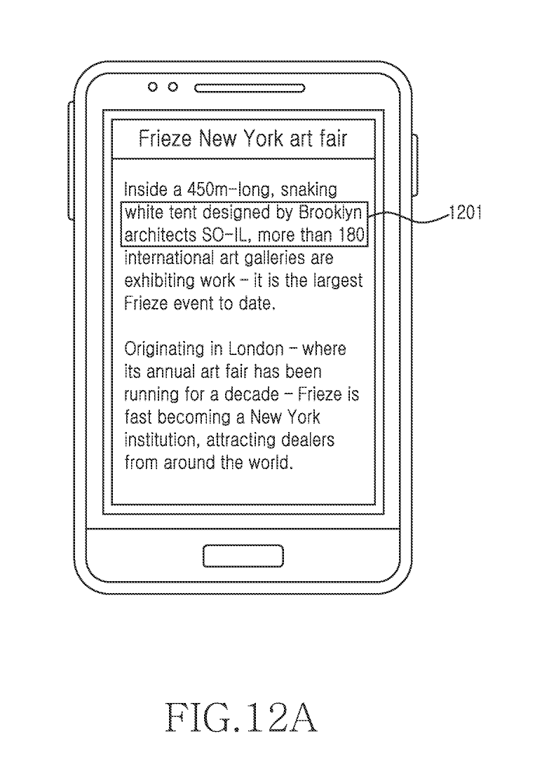

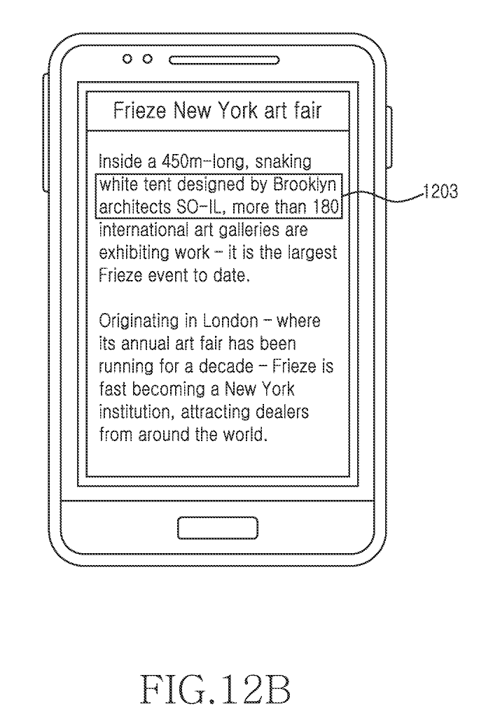

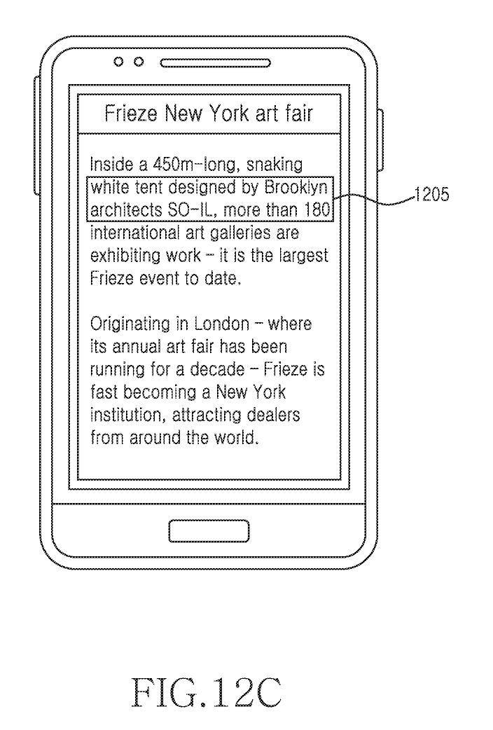

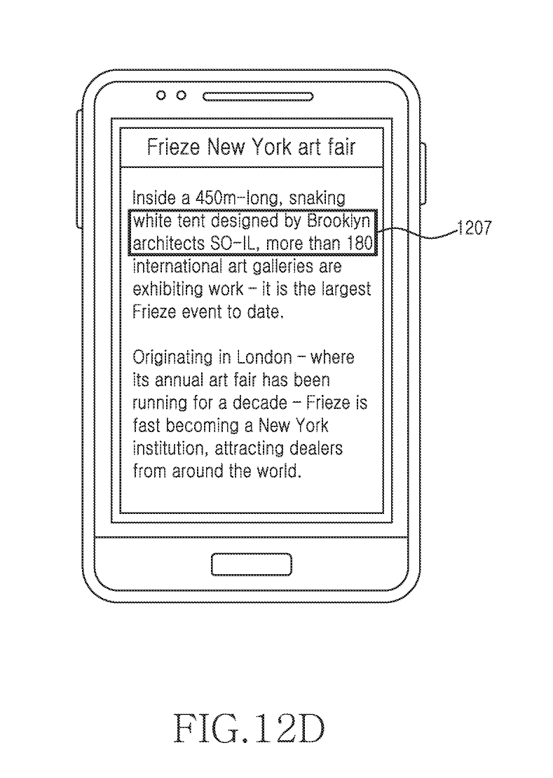

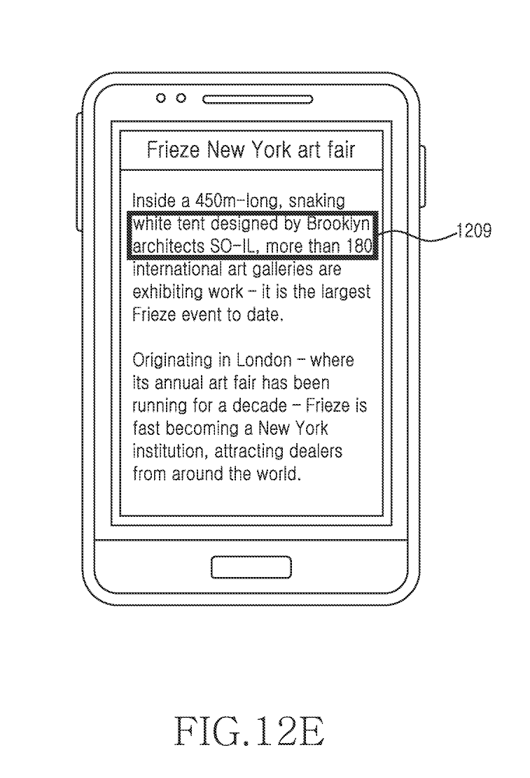

FIGS. 12A to 12E are electronic document screens illustrating a process of additionally assigning importance according to another embodiment of the present invention.

Referring to FIGS. 1 and 12A, the electronic device 100 may mark a marking region 1201 of a “white tent designed by Brooklyn architects SO-IL. More than 180” with a blue box type on an electronic document displayed on the display unit 152 in consideration of at least one of touch information provided from the touch input unit 151 and marking information.

If the marking region 1201 will be additionally marked, the electronic device 100 may modify a marking color and mark the marking region additionally with the modified marking color. Referring to FIG. 12B, as an example, the electronic device 100 may mark the marking region 1203 of the “white tent designed by Brooklyn architects SO-IL. More than 180” additionally with a green box type. Referring to FIG. 12C, if the marking region 1203 will be marked again and additionally, the electronic device 100 may mark the marking region 1205 of the “white tent designed by Brooklyn architects SO-IL. More than 180” with a red box type. In this case, the electronic device 100 updates importance of the marking region 1201 according to additional marking information. The electronic device 100 may apply a weight value for updating importance differently according to the number of times additionally marking the marking region.

In contrast, when the marking region 1201 will be additionally marked, the electronic device 100 may mark the marking region 1201 with a shape in which marking types are overlapped. Referring to FIG. 12D, as an example, the electronic device 100 may mark the marking region 1207 of the “white tent designed by Brooklyn architects SO-IL. More than 180” additionally with a shape in which blue boxes are overlapped. Accordingly, the electronic device 100 may display the marking region 1207 such that thickness of the blue box of FIG. 12D is thicker than that of the blue box of FIG. 12A. Referring to FIG. 12E, if the marking region 1207 will be marked again and additionally, the electronic device 100 may mark the marking region 1209 of the “white tent designed by Brooklyn architects SO-IL. More than 180” additionally with a type in which blue boxes are overlapped three times. Accordingly, the electronic device 100 may display the marking region 1209 such that the thickness of the blue box of FIG. 12E is thicker than that of the blue box of FIG. 12D. In this case, the electronic device 100 updates importance of the marking region 1201 according to additional marking information. The electronic device 100 may apply a weight value for updating importance differently according to the number of times additionally marking the marking region.

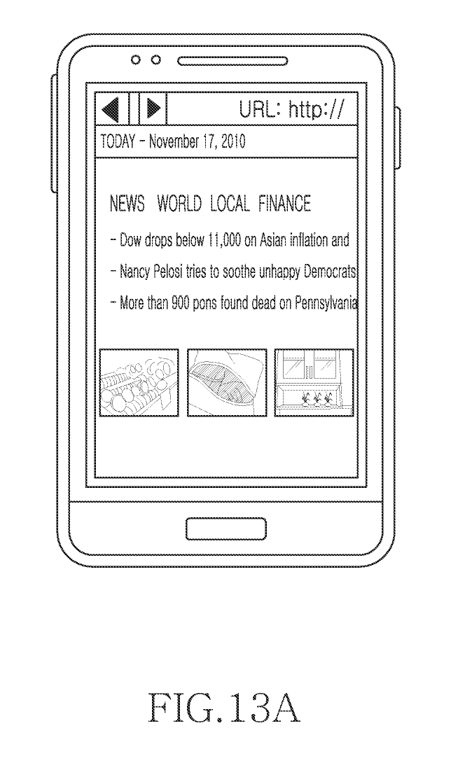

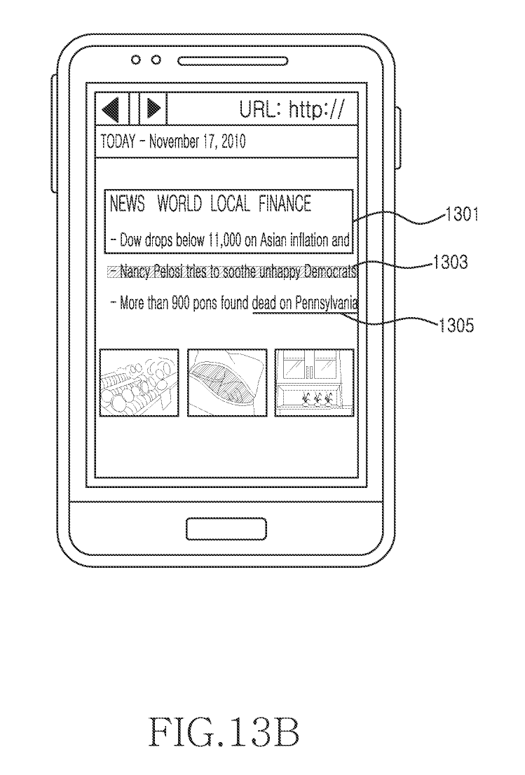

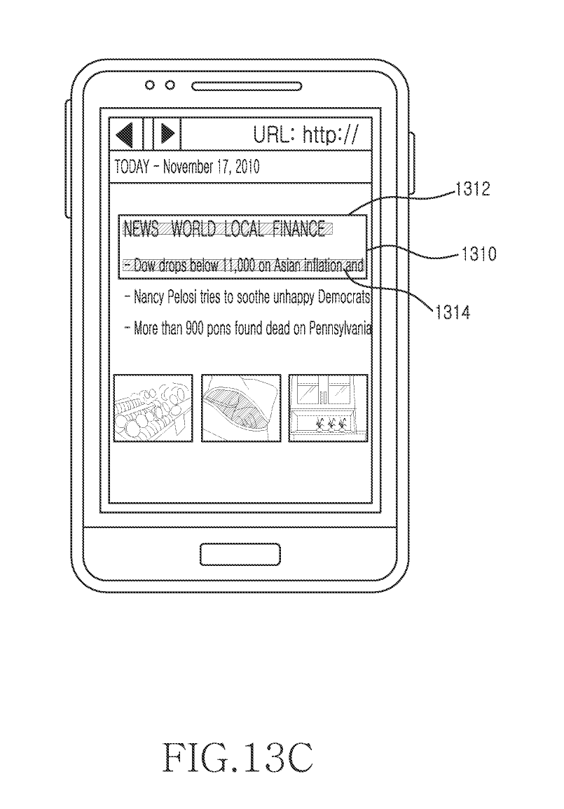

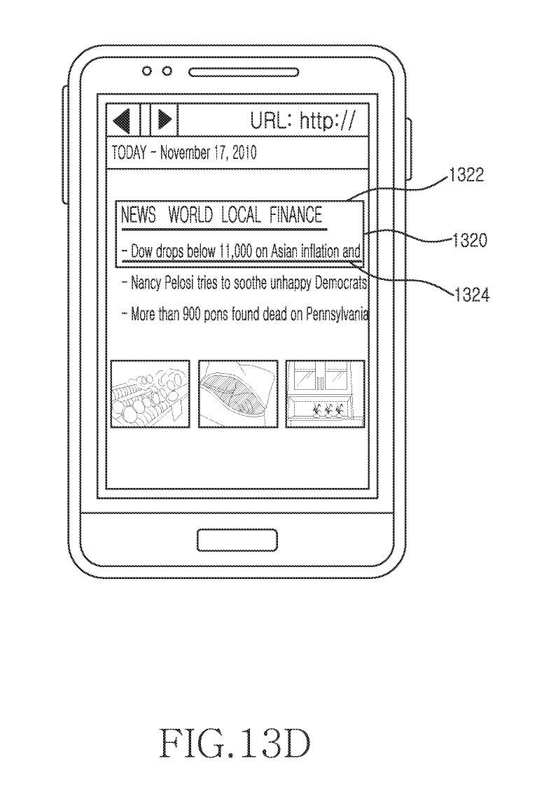

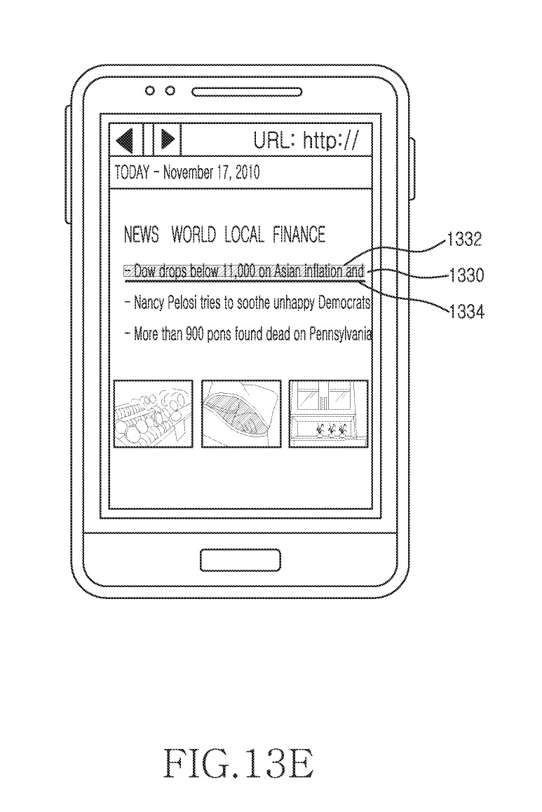

Referring to FIGS. 13A to 13E, the electronic device 100 may assign importance according to marking information of a marking region on a webpage displayed on the display unit 152.

FIGS. 13A to 13E are webpage screens illustrating a process of assigning importance according to an exemplary embodiment of the present invention.

Referring to FIGS. 1 and 13A, when the electronic device 100 provides a web search service, the electronic device 100 displays a webpage on the display unit 152. The electronic device 100 may mark a marking region of the webpage displayed on the display unit 152 in consideration of at least one of touch information provided from the touch input unit 151 and predetermined marking information. Referring to FIG. 13B, as an example, when marking information is set to a blue box type, the electronic device 100 may mark a first marking region 1301 of “NEWS WORLD LOCAL FINANCE—Dow drops below 11,000 on Asian inflation and” with the blue box type. As another example, when marking information is set to a red highlighter type, as shown in FIG. 13B, the electronic device 100 may mark a second marking region 1303 of “—Nancy Pelosi tries to soothe unhappy Democrats” with the red highlighter type according to the marking information. As another example, when marking information is set to a red underline type, as shown in FIG. 13B, the electronic device 100 may mark a third marking region 1305 of a “dead on Pennsylvania” with the red underline type according to the marking information. As another example, when the user touches a marking region as a box type through the touch input unit 151, as shown in FIG. 13B, the electronic device 100 may mark the first marking region 1301 of the “NEWS WORLD LOCAL FINANCE—Dow drops below 11,000 on Asian inflation and” with the box type. The electronic device 100 marks the first marking region 1301 with the blue box type according to predetermined touch information. The electronic device 100 assigns importance of each of the first to third marking regions 1301 to 1305 according to a marking type and a marking color of each of the first to third marking regions 1301 to 1305.

If the marking region is previously marked, the electronic device 100 modifies a marking type and marks the marking region additionally with the modified marking type. Referring to FIG. 13C, as an example, when the first marking region 1310 marked with the blue box type 1312 will be additionally marked, the electronic device 100 may mark the first marking region 1310 with a red highlighter type 1314 additionally. Referring to FIG. 13D, as an example, when the first marking region 1320 marked with the blue box type 1322 will be additionally marked, the electronic device 100 may mark the first marking region 1320 with a red underline type 1324 additionally. Referring to FIG. 13E, as an example, when the first marking region 1330 marked with the red highlighter type 1332 will be additionally marked, the electronic device 100 may mark the first marking region 1330 with a red underline type 1334 additionally. As another example, when a first marking region 1310 marked with a red highlighter type 1314 will be additionally marked, as shown in FIG. 13C, the electronic device 100 may mark the first marking region 1310 with a blue box type 1312 additionally. As another example, when a first marking region 1320 marked with a red underline type 1324 will be additionally marked, as shown in FIG. 13D, the electronic device 100 may mark the first marking region 1320 with a blue box type 1322 additionally. As another example, when a first marking region 1330 marked with a red underline type 1334 will be additionally marked, as shown in FIG. 13E, the electronic device 100 may mark the first marking region 1330 with a red highlighter type 1332 additionally. The electronic device 100 updates importance of the marking region in consideration of at least one of the additionally marked types and colors.

According to exemplary embodiments of the present invention described above, the electronic device 100 may modify a marking type and mark a marking region additionally with the modified marking type.

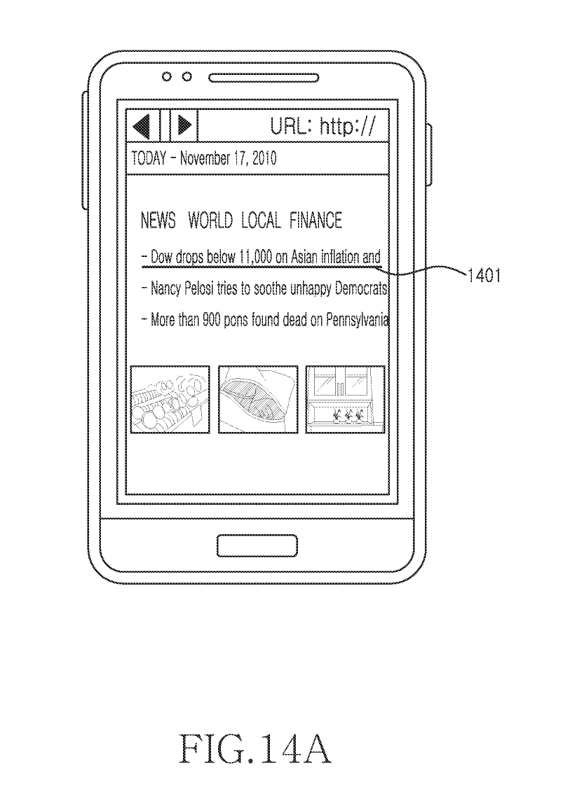

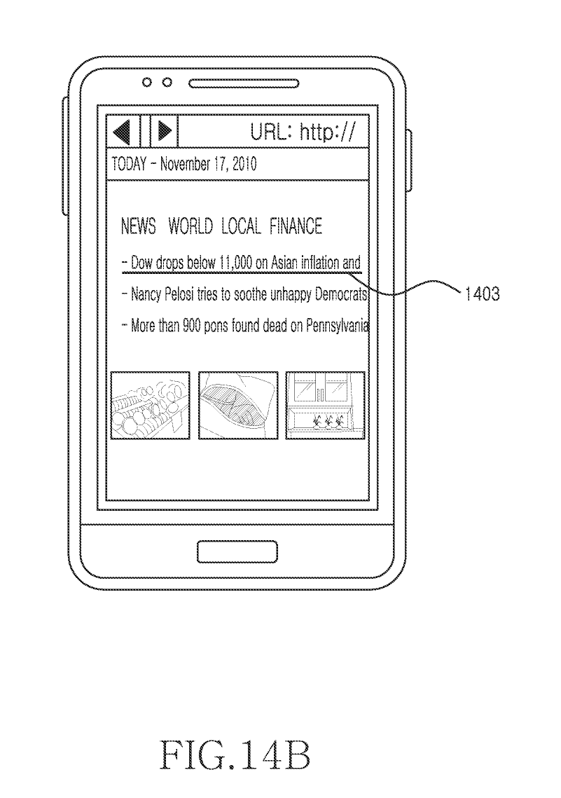

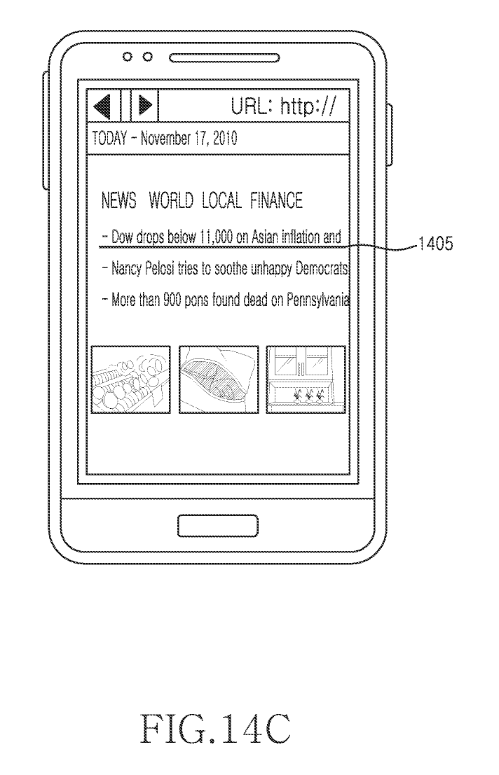

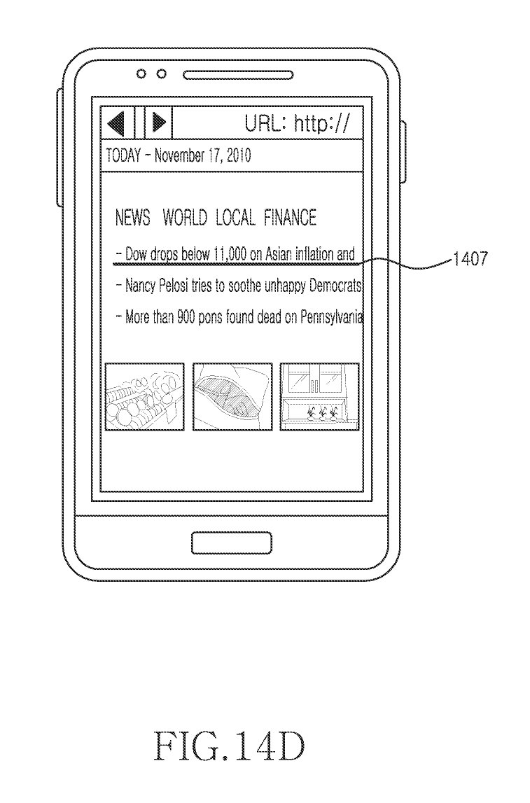

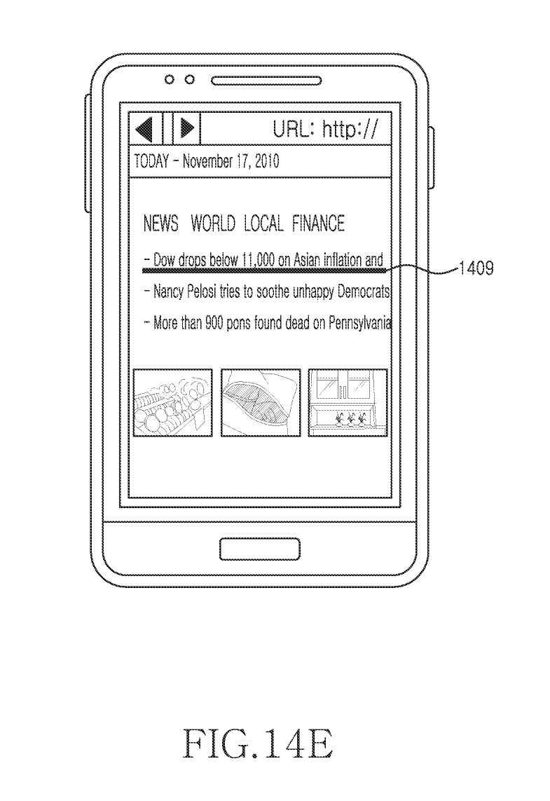

According to exemplary embodiments of the present invention, as shown in FIGS. 14A to 16E, the electronic device 100 may modify a marking color and mark a marking region with the modified marking color or a shape in which marking types are overlapped.

FIGS. 14A to 14E are webpage screens illustrating a process of additionally assigning importance according to an exemplary embodiment of the present invention.

Referring to FIGS. 1 and 14A, the electronic device 100 may mark a marking region 1401 of a “Dow drops below 11,000 on Asian inflation and” with a red underline type on a webpage displayed on the display unit 152 in consideration of at least one of touch information provided from the touch input unit 151 and marking information.

If the marking region 1401 will be additionally marked, the electronic device 100 may modify a marking color and mark a marking region additionally with the modified marking color. Referring to FIG. 14B, as an example, the electronic device 100 may mark the marking region 1403 of the “Dow drops below 11,000 on Asian inflation and” additionally with a green underline type. Referring to FIG. 14C, if the marking region 1403 will be marked again and additionally, the electronic device 100 may mark the marking region 1405 of the “Dow drops below 11,000 on Asian inflation and” with a blue underline type. In this case, the electronic device 100 updates importance of the marking region 1401 according to additional marking information. The electronic device 100 may apply a weight value for updating importance differently according to the number of times additionally marking the marking region.

In contrast, when the marking region 1401 will be additionally marked, the electronic device 100 may mark the marking region 1401 with a shape in which marking types are overlapped. Referring to FIG. 14D, as an example, the electronic device 100 may mark the marking region 1407 of the “Dow drops below 11,000 on Asian inflation and” additionally with a shape in which red underlines are overlapped. Accordingly, the electronic device 100 may display the marking region 1407 such that a width of the red underline of FIG. 14D is broader than that of the red underline of FIG. 14A. Referring to FIG. 14E, if the marking region 1407 will be marked again and additionally, the electronic device 100 may mark the marking region 1409 of the “Dow drops below 11,000 on Asian inflation and” additionally with a type in which red underlines are overlapped three times. Accordingly, the electronic device 100 may display the marking region 1409 such that a width of the red underline of FIG. 14E is broader than that of the red underline of FIG. 14D. In this case, the electronic device 100 may update importance of the marking region 1401 according to additional marking information. The electronic device 100 may apply a weight value for updating importance differently according to the number of times additionally marking the marking region.

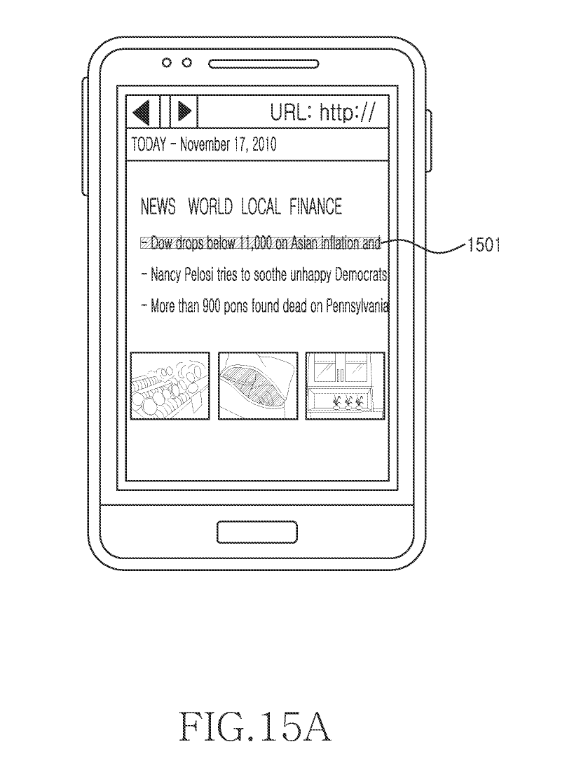

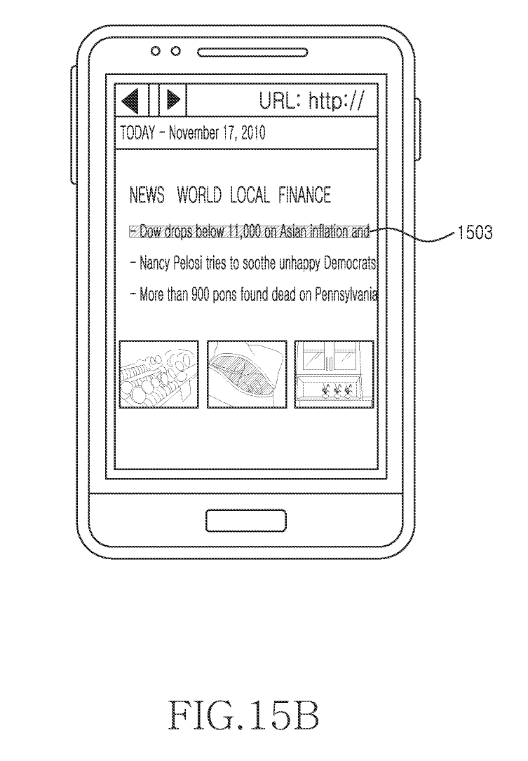

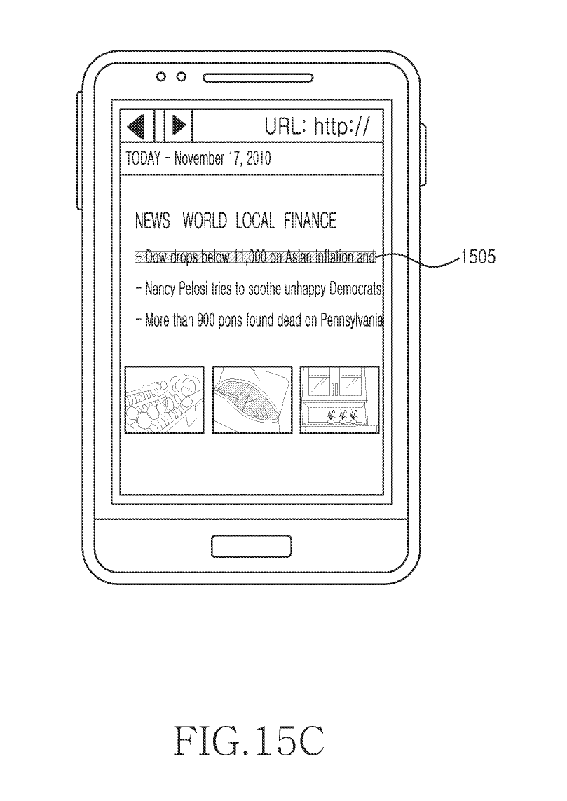

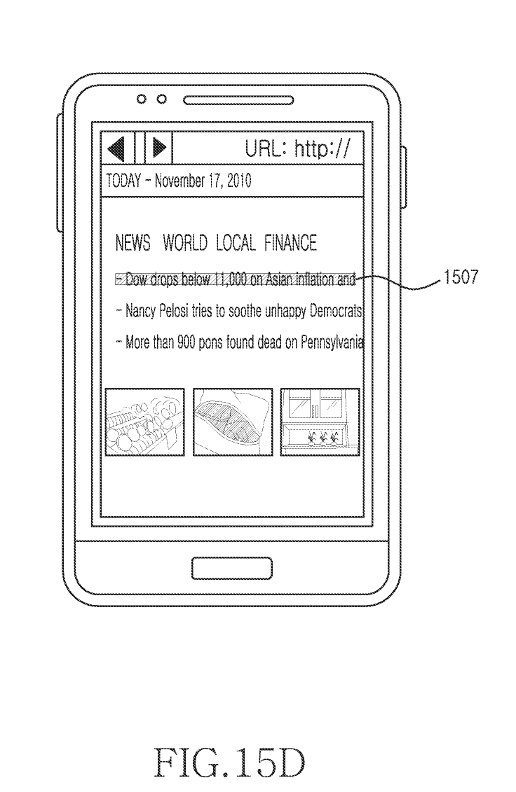

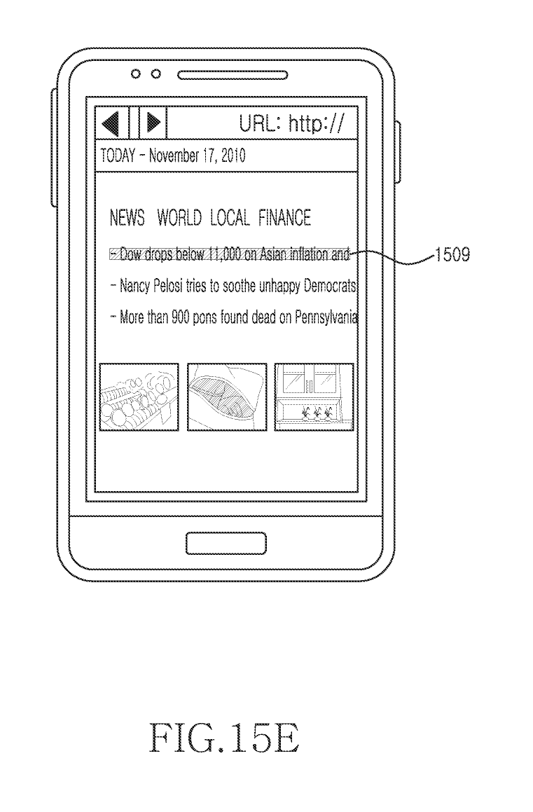

FIGS. 15A to 15E are webpage screens illustrating a process of additionally assigning importance according to an exemplary embodiment of the present invention.

Referring to FIGS. 1 and 15A, the electronic device 100 may mark a marking region 1501 of a “Dow drops below 11,000 on Asian inflation and” with a red highlighter type on a webpage displayed on the display unit 152 in consideration of at least one of touch information provided from the touch input unit 151 and marking information.

If the marking region 1501 will be additionally marked, the electronic device 100 may modify a marking color and mark the marking region additionally with the modified marking color. Referring to FIG. 15B, as an example, the electronic device 100 may mark the marking region 1503 of the “Dow drops below 11,000 on Asian inflation and” additionally with a green highlighter type. Referring to FIG. 15C, if the marking region 1503 illustrated in FIG. 15B will be marked again and additionally, the electronic device 100 may mark the marking region 1505 of the “Dow drops below 11,000 on Asian inflation and” with a blue highlighter type. In this case, the electronic device 100 may update importance of the marking region 1501 according to additional marking information. The electronic device 100 may apply a weight value for updating importance differently according to the number of times additionally marking the marking region.

In contrast, when the marking region 1501 will be additionally marked, the electronic device 100 may mark the marking region 1501 with a shape in which marking types are overlapped. Referring to FIG. 15D, as an example, the electronic device 100 may mark the marking region 1507 of the “Dow drops below 11,000 on Asian inflation and” additionally with a shape in which red highlighters are overlapped. Accordingly, the electronic device 100 may display the marking region 1507 such that transparency of the red highlighter of FIG. 15D is darker than that of the red highlighter of FIG. 15A. Referring to FIG. 15E, if the marking region 1507 will be marked again and additionally, the electronic device 100 may mark the marking region 1509 of the “Dow drops below 11,000 on Asian inflation and” additionally with a type in which red highlighters are overlapped three times. Accordingly, the electronic device 100 may display the marking region 1509 such that the transparency of the red highlighter of FIG. 15E is darker than that of the red highlighter of FIG. 15D. In this case, the electronic device 100 updates importance of the marking region 1501 according to additional marking information. The electronic device 100 may apply a weight value for updating importance differently according to the number of times additionally marking the marking region.

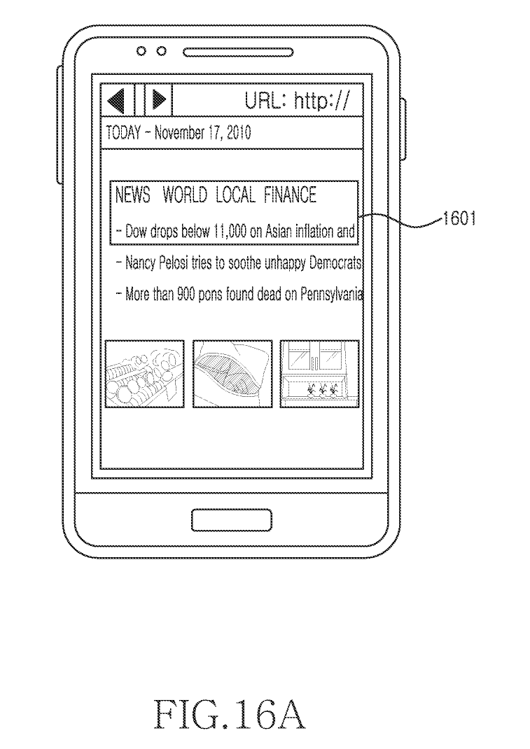

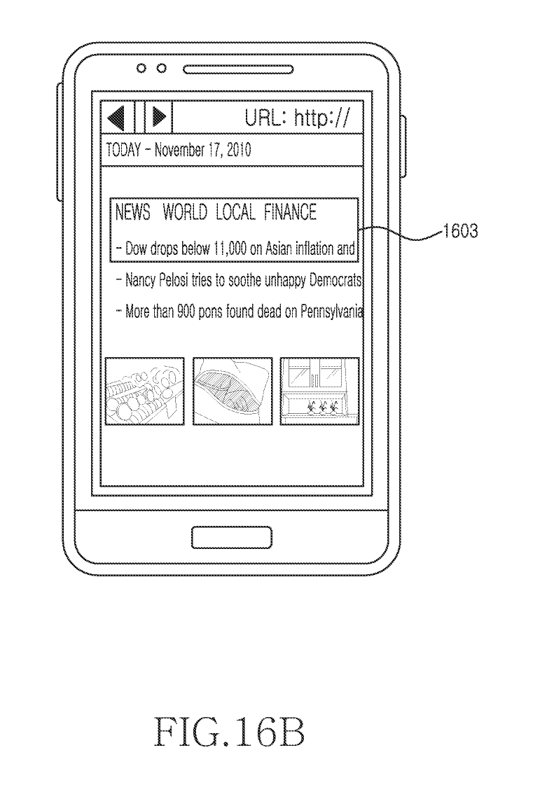

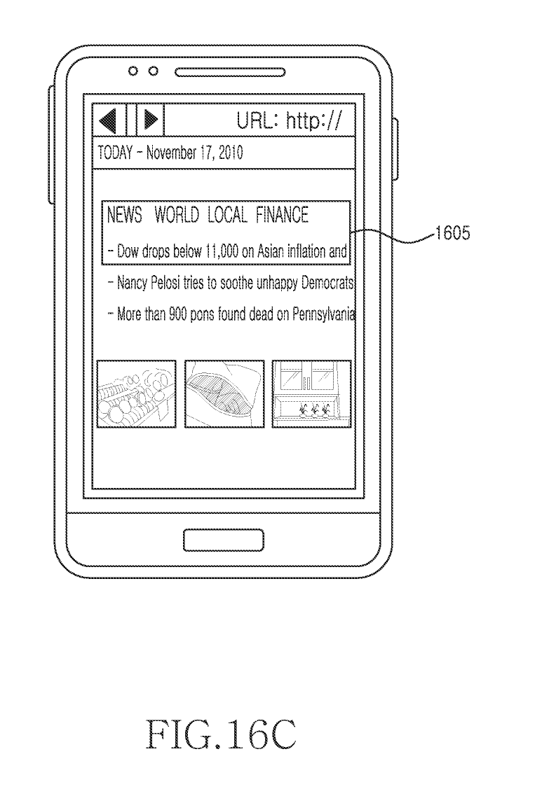

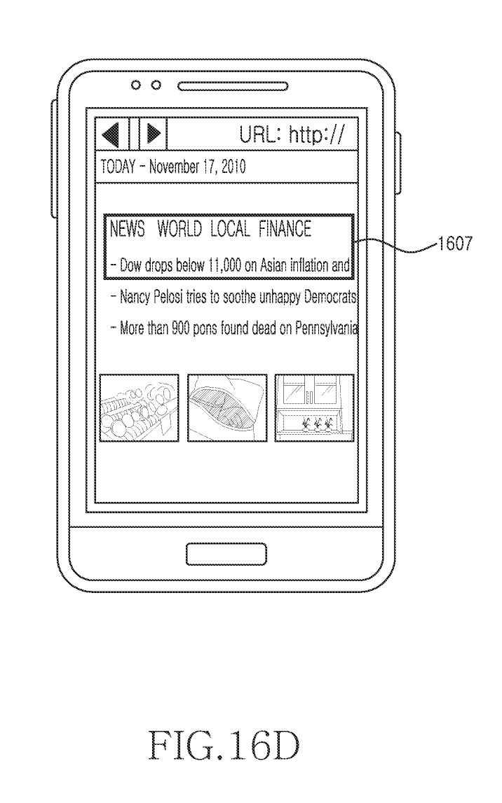

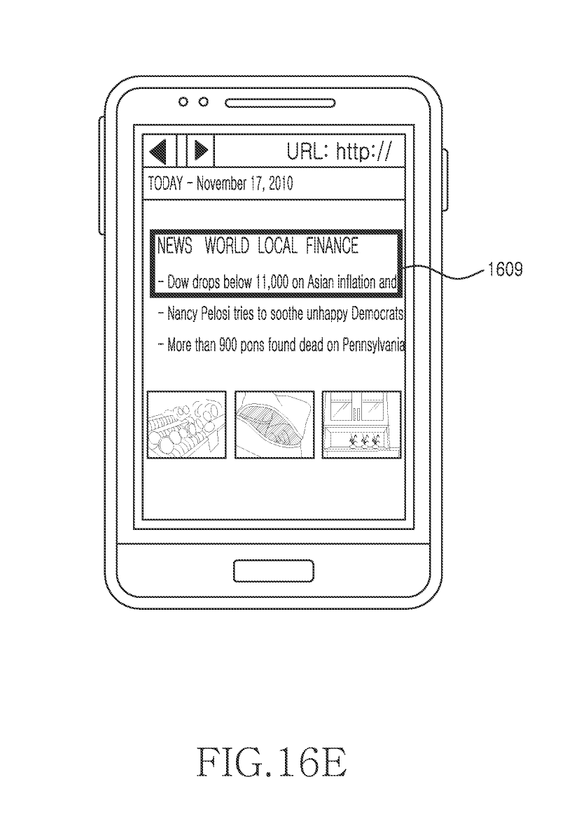

FIGS. 16A to 16E are webpage screens illustrating a process of additionally assigning importance according to an exemplary embodiment of the present invention.

Referring to FIGS. 1 and 16A, the electronic device 100 may mark a marking region 1601 of a “NEWS WORLD LOCAL FINANCE—Dow drops below 11,000 on Asian inflation and” with a blue box type on a webpage displayed on the display unit 152 in consideration of at least one of touch information provided from the touch input unit 151 and marking information.

If the marking region 1601 will be additionally marked, the electronic device 100 may modify a marking color and mark the marking region additionally with the modified marking color. Referring to FIG. 16B, as an example, the electronic device 100 may mark the marking region 1603 of the “NEWS WORLD LOCAL FINANCE—Dow drops below 11,000 on Asian inflation and” additionally with a green box type. Referring to FIG. 16C, if the marking region 1603 will be marked again and additionally, the electronic device 100 may mark the marking region 1605 of the “NEWS WORLD LOCAL FINANCE—Dow drops below 11,000 on Asian inflation and” with a red box type. In this case, the electronic device 100 updates importance of the marking region 1601 according to additional marking information. The electronic device 100 may apply a weight value for updating importance differently according to the number of times additionally marking the marking region.

In contrast, when the marking region 1601 will be additionally marked, the electronic device 100 may mark the marking region 1601 with a shape in which marking types are overlapped. Referring to FIG. 16D, as an example, the electronic device 100 may mark the marking region 1607 of the “NEWS WORLD LOCAL FINANCE—Dow drops below 11,000 on Asian inflation and” additionally with a shape in which blue boxes are overlapped. Accordingly, the electronic device 100 may display the marking region 1607 such that thickness of the blue box of FIG. 16D is thicker than that of the blue box of FIG. 16A. Referring to FIG. 16E, if the marking region 1607 will be marked again and additionally, the electronic device 100 may mark the marking region 1609 of the “NEWS WORLD LOCAL FINANCE—Dow drops below 11,000 on Asian inflation and” additionally with a type in which blue boxes are overlapped three times. Accordingly, the electronic device 100 may display the marking region 1609 such that the thickness of the blue box of FIG. 16E is thicker than that of the blue box of FIG. 16D. In this case, the electronic device 100 updates importance of the marking region 1601 according to additional marking information. The electronic device 100 may apply a weight value for updating importance differently according to the number of times additionally marking the marking region.

According to exemplary embodiments of the present invention described above, when an additional marking event is generated, the electronic device 100 may mark all of the marking region additionally and update importance of all of the marking region according to additional marking information.

According to exemplary embodiments of the present invention, the electronic device 100 may mark a part of the marking region additionally according to a size of the marking region, which is set to mark the marking region additionally, and update importance of a part of the marking region according to additional marking information.

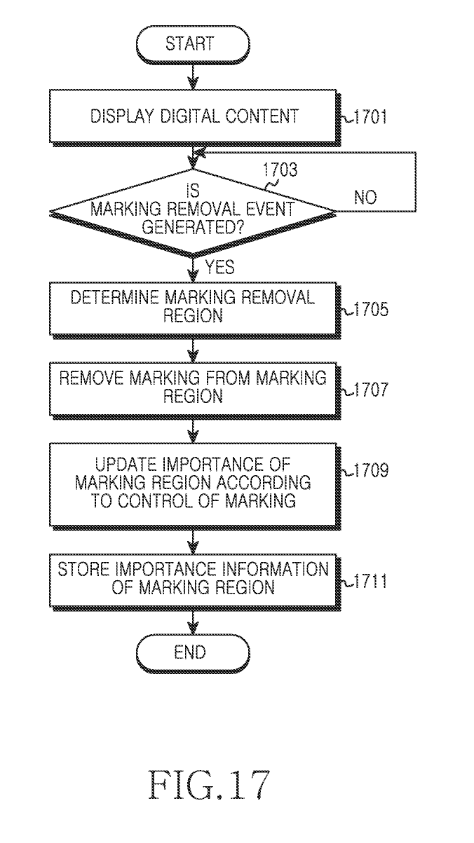

FIG. 17 is a flowchart illustrating a process of removing importance from digital content according to an exemplary embodiment of the present invention.

Referring to FIGS. 1 and 17, the electronic device 100 displays digital content for providing a service in step 1701. For example, the electronic device 100 may display any one of an SNS screen, an electronic document, and a webpage on the display unit 152 according to a kind of a service. If importance is set to the digital content, the electronic device 100 may mark a region to which the importance is assigned according to the importance.

Thereafter, the electronic device 100 proceeds to step 1703 in which the electronic device 100 determines (e.g., determines) whether a marking removal event is generated. For one example, the electronic device 100 may determine whether a marking removal icon displayed on the display unit 152 is selected. As another example, the electronic device 100 may determine whether a marking removal menu is selected by an operation of the user. As another example, the electronic device 100 may determine whether a marking removal button is pushed. As another example, the electronic device 100 may determine whether marking removal information is received from a touch pen.

When the electronic device 100 determines that the marking removal event is generated in step 1703, the electronic device 100 proceeds to step 1705 in which the electronic device 100 determines a marking removal region in consideration of touch information sensed through the touch input unit 151. For example, the electronic device 100 may recognize a marking region touched on the digital content displayed on the display unit 151 by the user as a marking removal region.

After determining the marking removal region in step 1705, the electronic device 100 proceeds to step 1707 in which the electronic device 100 removes the marking of the marking region. For example, when the marking of the first marking region 605 shown in FIG. 6C will be removed, as shown in FIG. 5A, the electronic device 100 may remove the marking of the first marking region 605. As another example, when the marking of the first marking region 605 shown in FIG. 6C will be removed, as shown in FIG. 6B, the electronic device 100 may display the marking of the first marking region 603 with a green underline type.

After removing the marking of the marking region in step 1707, the electronic device 100 proceeds to step 1709 in which the electronic device 100 updates importance of the marking region according to marking information of the marking region. For example, the electronic device 100 may update importance of the marking region in consideration of a marking type of the marking region according to the removal of the marking. As another example, the electronic device 100 may update importance of the marking region in consideration of a marking color of the marking region according to the removal of the marking. As another example, the electronic device 100 may update importance of the marking region in consideration of a marking type and a marking color of the marking region according to the removal of the marking.

After updating importance of the marking region in step 1709, the electronic device 100 proceeds to step 1711 in which the electronic device 100 stores the updated importance of the marking region.

The electronic device 100 ends the algorithm of FIG. 17.

According to exemplary embodiments of the present invention described above, when the marking removal event is generated, the electronic device 100 may remove the marking of the marking region.

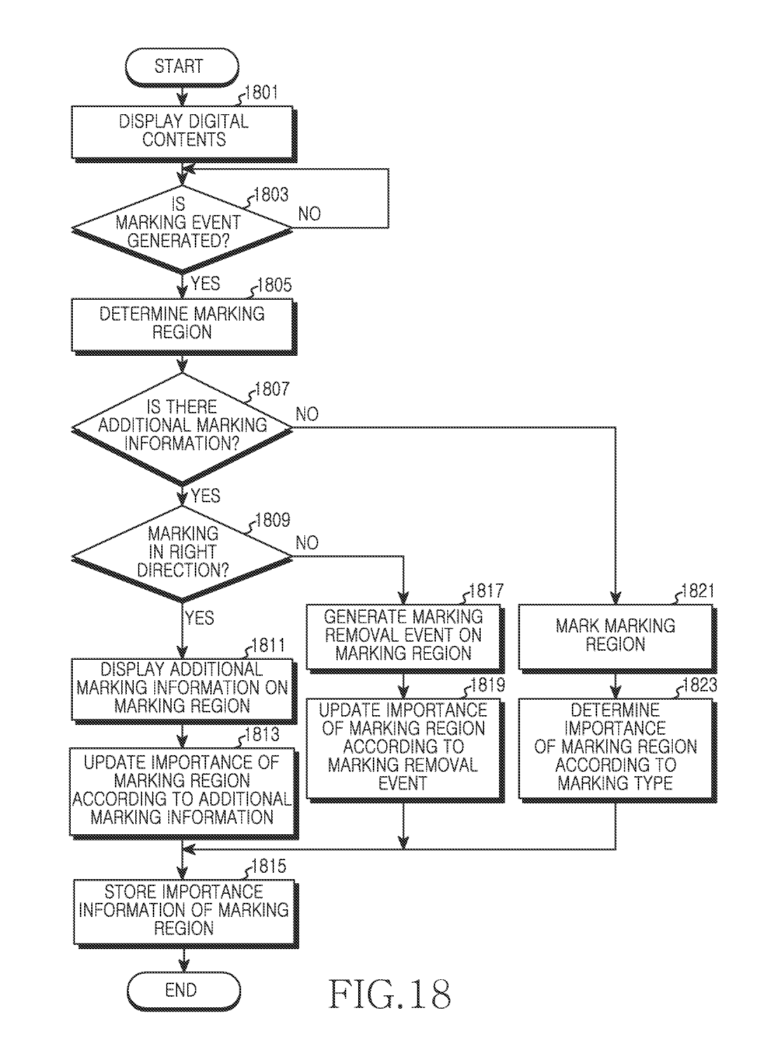

According to exemplary embodiments of the present invention, as shown in FIG. 18, the electronic device 100 may mark a marking region or remove the marking of the marking region in consideration of touch information for marking the marking region.

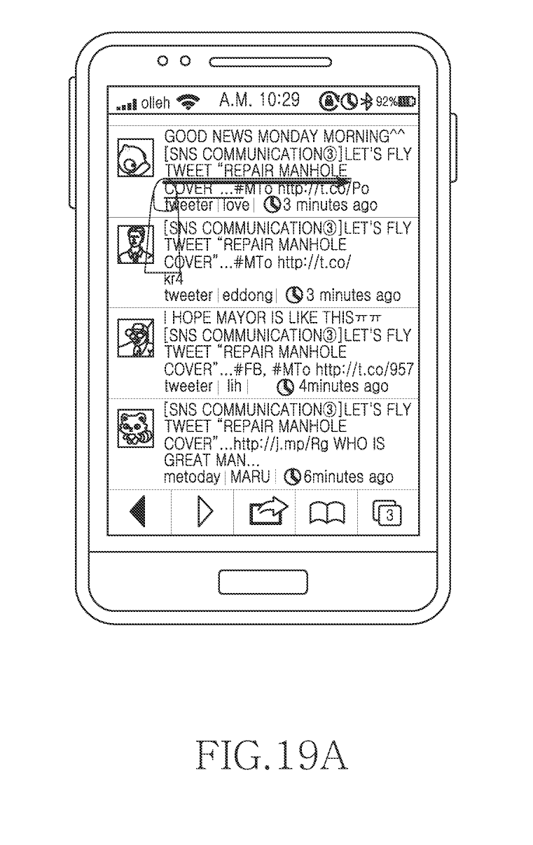

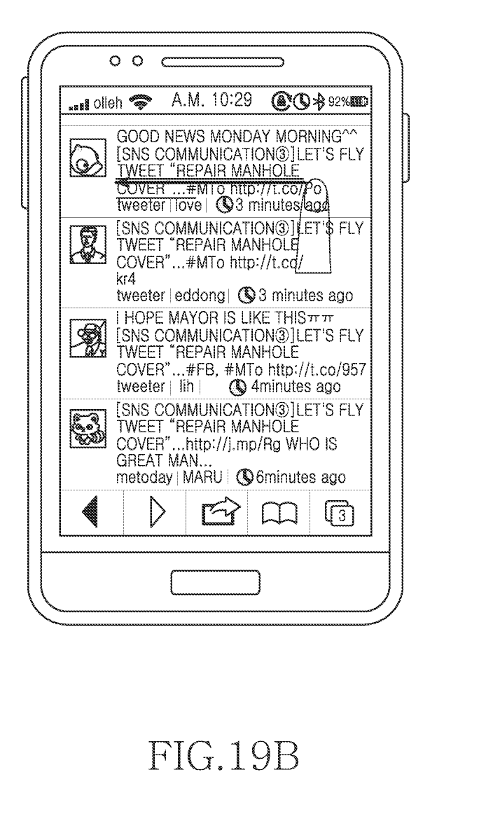

FIG. 18 is a flowchart illustrating a process of removing importance from digital content according to an exemplary embodiment of the present invention. FIGS. 19A and 19B are screens illustrating a process of removing importance from digital content according to an exemplary embodiment of the present invention.

Referring to FIGS. 1 and 18, the electronic device 100 displays digital content for providing a service in step 1801. For example, the electronic device 100 may display any one of an SNS screen, an electronic document, and a webpage on the display unit 152 according to a kind of a service. If importance is set to the digital content, the electronic device 100 may mark a region to which the importance is assigned according to the importance.

Thereafter, the electronic device 100 proceeds to step 1803 in which the electronic device 100 determines (e.g., determines) whether a marking event is generated. For example, the electronic device 100 may determine whether a marking icon displayed on the display unit 152 is selected. As another example, the electronic device 100 may determine whether a marking setup menu is selected by an operation of the user. As another example, the electronic device 100 may determine whether a marking setup button is pushed. As another example, the electronic device 100 may determine whether marking setup information is received from a touch pen.

When the electronic device 100 determines that the marking event is generated in step 1803, the electronic device 100 proceeds to step 1805 in which the electronic device 100 determines a marking region in consideration of touch information sensed through the touch input unit 151. For example, the electronic device 100 may recognize a region touched on the digital content displayed on the display unit 151 by the user as a marking region.

After determining the marking region in step 1805, the electronic device 100 proceeds to step 1807 in which the electronic device 100 determines (e.g., determines) whether the marking region determined in step 1805 is previously marked.

If the electronic device 100 determines that the marking region determined in step 1805 is not previously marked in step 1807, then the electronic device 100 proceeds to step 1821 in which the electronic device 100 marks the marking region according to predetermined marking information. The electronic device 100 may use marking information which is set to a basic value or marking information used when providing a previous marking service. The marking information includes a marking type and a marking color. The marking type includes a box type, a highlighter type, and an underline type.

After marking the marking region, the electronic device 100 proceeds to step 1823 in which the electronic device 100 determines importance of the marking region according to the marking information of the marking region. For example, the electronic device 100 may determine importance of the marking region in consideration of a marking type of the marking region. As another example, the electronic device 100 may determine importance of the marking region in consideration of a marking color of the marking region. As another example, the electronic device 100 may determine importance of the marking region in consideration of a marking type and a marking color of the marking region.

Thereafter, the electronic device 100 proceeds to step 1815 in which the electronic device 100 extracts content information included in the marking region, and stores the extracted content information together with importance information. For example, the electronic device 100 extracts text information included in the marking region and stores the extracted text information together with importance information.

In contrast, if the electronic device 100 determines that the marking region determined in step 1805 is previously marked in step 1807, then the electronic device 100 proceeds to step 1809 in which the electronic device 100 determines (e.g., determines) a touch direction for selecting the marking region. For example, as shown in FIG. 19A, the electronic device 100 may determine whether a touch point is changed from the touch point to the right.

When the electronic device 100 determines that the touch point is changed from the touch point to the right according to touch information for setting a marking region in step 1809, the electronic device 100 recognizes that an additional marking event for the marking region is generated. Accordingly, the electronic device 100 proceeds to step 1811 in which the electronic device 100 marks the marking region additionally. For example, the electronic device 100 may modify a marking type and mark a marking region additionally with the modified marking type. As another example, the electronic device 100 may modify a marking color and mark a marking region additionally with the modified marking color. As another example, the electronic device 100 may mark a marking region additionally with a shape in which the same marking types are overlapped.

After additionally marking the marking region in step 1811, the electronic device 100 proceeds to step 1813 in which the electronic device 100 updates importance of the marking region according to additional marking information. The electronic device 100 may apply a weight value for updating importance to at least one of an additional marking type, an additional marking color, and the number of times additionally marking the marking region and update importance of the marking region.

Thereafter, the electronic device 100 proceeds to step 1815 in which the electronic device 100 stores importance information of content information included in the marking region.

In contrast, when the electronic device 100 determines that the touch point is not changed from the touch point to the right according to touch information for setting the marking region in step 1809, the electronic device 100 recognizes that a marking removal event for the marking region is generated. For example, as shown in FIG. 19B, when a touch point is changed from the touch point to the left, the electronic device 100 may recognize that the marking removal event for the marking region is generated.

Accordingly, the electronic device 100 may proceed to step 1817 in which the electronic device 100 removes the marking of the marking region. For example, when the marking of the first marking region 605 shown in FIG. 6C will be removed, as shown in FIG. 5A, the electronic device 100 may remove the marking of the first marking region 605. As another example, when the marking of the first marking region 605 shown in FIG. 6C will be removed, as shown in FIG. 6B, the electronic device 100 may display the marking of the first marking region 603 with a green underline type.

After removing the marking of the marking region in step 1817, the electronic device 100 proceeds to step 1819 in which the electronic device 100 updates importance of the marking region according to marking information of the marking region. For example, the electronic device 100 may update importance of the marking region in consideration of a marking type of the marking region according to the removal of the marking. As another example, the electronic device 100 may update importance of the marking region in consideration of a marking color of the marking region according to the removal of the marking. As another example, the electronic device 100 may update importance of the marking region in consideration of a marking type and a marking color of the marking region according to the removal of the marking.

Thereafter, the electronic device 100 proceeds to step 1815 in which the electronic device 100 stores importance information of content information included in the marking region.

The electronic device 100 ends the algorithm of FIG. 18.

According to exemplary embodiments of the present invention described above, when the marking removal event is generated, the electronic device 100 may remove the marking of all of the marking region and update importance of all of the marking region according to marking removal information.

According to exemplary embodiments of the present invention, the electronic device 100 may remove only a part of the marking region according to a size of a marking removal region for removing the marking and update importance of a part of the marking region according to marking removal information.

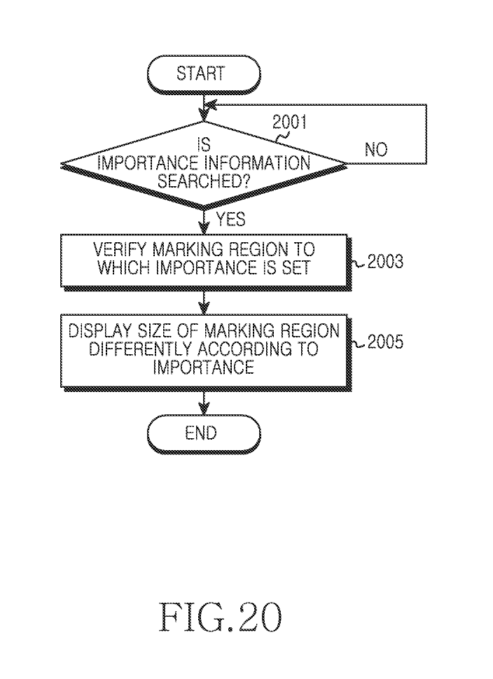

FIG. 20 is a flowchart illustrating a process of displaying importance information of digital content according to an exemplary embodiment of the present invention.

Referring to FIGS. 1 and 20, the electronic device 100 determines (e.g., determines) whether an importance information search event is generated in step 2001. For example, the electronic device 100 may determine whether an importance information search icon displayed on the display unit 152 is selected. As another example, the electronic device 100 may determine whether an importance information search menu is selected by an operation of the user. As another example, the electronic device 100 may determine whether an importance information search button is pushed.

When the importance information search event is generated, the electronic device 100 proceeds to step 2003 in which the electronic device 100 determines marking region information to which importance is assigned, which is stored in the data storing unit 112.

After determining the marking region information to which the importance is assigned in step 2003, the electronic device 100 proceeds to step 2005 in which the electronic device 100 displays a size of digital content included in the marking region differently according to importance. For example, as shown in FIG. 22A, the electronic device 100 may store “London” information 2205 which has an importance 3, “a 450 m-long” information 2201 which has an importance 2, and “SO-IL” information 2203 which has an importance 1. If an importance information search event is generated, as shown in FIG. 22B, the electronic device 100 may display the first largest “London” information 2205, the second largest “a 450 m-long” information 2201, and the smallest “SO-IL” information 2203 in order of importance.

The electronic device 100 ends the algorithm of FIG. 20.

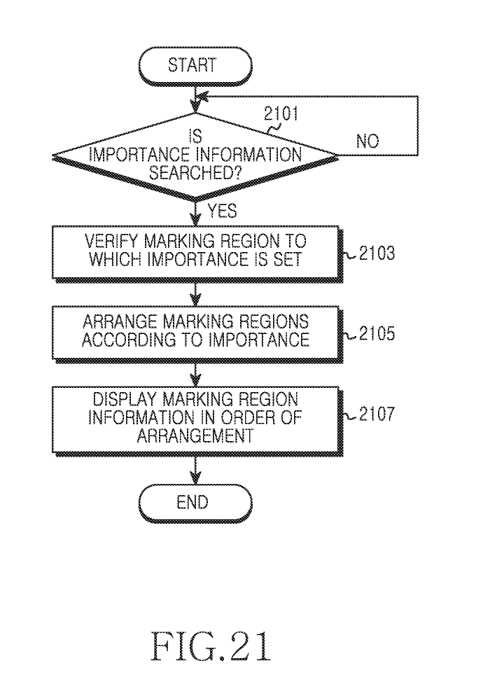

FIG. 21 is a flowchart illustrating a process of displaying importance information of digital content according to an exemplary embodiment of the present invention.

Referring to FIGS. 1 and 21, the electronic device 100 determines (e.g., determines) whether an importance information search event is generated in step 2101. For one example, the electronic device 100 may determine whether an importance information search icon displayed on the display unit 152 is selected. As another example, the electronic device 100 may determine whether an importance information search menu is selected by an operation of the user. As another example, the electronic device 100 may determine whether an importance information search button is pushed.

When the electronic device 100 determines that the importance information search event is generated in step 2101, the electronic device 100 proceeds to step 2103 in which the electronic device 100 determines marking region information to which importance is assigned, which is stored in the data storing unit 112.

After determining the marking region information to which the importance is assigned in step 2103, the electronic device 100 proceeds to step 2105 in which the electronic device 100 assigns (e.g., arranges) marking regions to which importance is assigned according to the importance assigned to each marking region.

After assigning (e.g., arranging) the marking regions to which importance is assigned in step 2105, the electronic device 100 proceeds to step 2107 in which the electronic device 100 displays marking region information to which importance is assigned according to an order of assignment. For example, as shown in FIG. 22A, the electronic device 100 may store “a 450 m-long” information 2201 which has an importance 3, “SO-IL” information 2203 which has an importance 2, and “London” information 2205 which has an importance 1. If an importance information search event is generated, as shown in FIG. 22C, the electronic device 100 may display the “a 450 m-long” information 2201, the “SO-IL” information 2203, and the “London” information 2205 in order of importance on the display unit 152. The electronic device 100 may also display position information and importance information of each marking region together.

The electronic device 100 ends the algorithm of FIG. 21.

As described above, the electronic device may enhance utilization degree for digital content to utilize the digital content such as the user uses paper books or notes by assigning importance for a certain region of digital content in consideration of a marking type, a marking color, and the number of times marking a marking region.

It will be appreciated that exemplary embodiments of the present invention according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are exemplary embodiments of machine-readable storage that are suitable for storing a program or programs comprising instructions that, when executed, implement exemplary embodiments of the present invention. Accordingly, exemplary embodiments provide a program comprising code for implementing apparatus or a method as claimed in any one of the claims of this specification and a machine-readable storage storing such a program.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of assigning a degree of importance to content in an electronic device, the method comprising:
displaying the content on a display unit;
determining a marking region on the content displayed on the display unit;
marking the marking region; and
assigning the degree of importance to the marking region in consideration of marking information of the marking region.

2. The method of claim 1, wherein the displaying of the content comprises:
determining whether the marking region to which the importance is assigned is included in the content to be displayed on the display unit; and
displaying the content including at least marked one marking region on the display unit when the marking region to which the importance is assigned is included in the content.

3. The method of claim 1, wherein, when the display unit is a touch screen, the determination of the marking region comprises determining region information touched on the content displayed on the display unit as corresponding to the marking region for the content.

4. The method of claim 1, further comprising:
determining marking information for marking the marking region before marking the marking region,
wherein the marking of the marking region comprises marking the marking region according to the marking information.

5. The method of claim 1, wherein the marking information includes at least one of a marking type, a marking color, and a number of times the marking region has been marked.

6. The method of claim 1, wherein the marking of the marking region comprises:
determining a marking type and a marking color for the marking region in consideration of at least one of predetermined marking information and touch information for setting the marking region; and
marking the marking region in consideration of the determined marking type and marking color.

7. The method of claim 1, further comprising:
determining whether the marking region is previously marked after determining the marking region; and
additionally marking the marking region when the marking region is previously marked,
wherein the marking region is marked when the marking region is not previously marked.

8. The method of claim 7, wherein the additional marking of the marking region comprises additionally marking the marking region with a marking type which is different from the marking type with which the marking region is previously marked.

9. The method of claim 7, wherein the additional marking of the marking region comprises changing at least one of a marking color, marking transparency, and a marking width of the marking region in consideration of a number of times the marking region has been marked.

10. The method of claim 1, further comprising:
determining a marking removal region when a marking removal event is generated; and
removing the marking from the marking removal region,
wherein the marking removal region includes at least one marking region included in the content displayed on the display unit.

11. The method of claim 1, wherein the removal of the marking comprises removing the marking from the marking removal region in consideration of a number of times the marking removal region has been marked and a number of times the marking of the marking removal region has been removed.

12. An electronic device comprising:
a display unit for displaying content;
at least one processor;
a memory; and
a program which is stored in the memory and is executed the at least one processor,
wherein the at least one processor determines a marking region on the content displayed on the display unit, marks the marking region, and assigns a degree of importance to the marking region in consideration of marking information of the marking region.

13. The electronic device of claim 12, wherein the at least one processor determines whether the marking region to which the importance is assigned is included in the content when the content are displayed on the display unit, and displays the content including at least marked one marking region on the display unit when the marking region to which the importance is assigned is included in the content.

14. The electronic device of claim 12, wherein, when the display unit is a touch screen, the at least one processor determines region information touched on the content displayed on the display unit as corresponding to the marking region.

15. The electronic device of claim 12, wherein the at least one processor determines marking information for marking the marking region and marks the marking region according to the marking information.

16. The electronic device of claim 12, wherein the marking information includes at least one of a marking type, a marking color, and a number of times the marking region has been marked.

17. The electronic device of claim 12, wherein the at least one processor determines a marking type and a marking color for the marking region in consideration of at least one of predetermined marking information and touch information for setting the marking region, and marks the marking region in consideration of the determined marking type and marking color.

18. The electronic device of claim 12, wherein the at least one processor determines whether the marking region is previously marked after determining the marking region, additionally marks the marking region when the marking region is previously marked, and marks the marking region when the marking region is not previously marked.

19. The electronic device of claim 18, wherein each of the one or more processors additionally marks the marking region with a marking type which is different from the marking type with which the marking region is previously marked.

20. The electronic device of claim 18, wherein the at least one processor changes at least one of a marking color, a marking transparency, and a marking width of the marking region in consideration of a number of times the marking region has been marked.

21. The electronic device of claim 12, wherein the at least one processor determines a marking removal region when a marking removal event is generated, and removes the marking from the marking removal region,
wherein the marking removal region includes at least one marking region included in the content displayed on the display unit.

22. The electronic device of claim 21, wherein the at least one processor removes the marking from the marking removal region in consideration of a number of times the marking removal region has been marked and a number of times the marking of the marking removal region has been removed.
